(19) United States
(12) Patent Application Publication
(10) Pub. No.: US 2014/0157342 A1
(43) Pub. Date: Jun. 5, 2014

(54) RECEPTION DEVICE, TRANSMISSION DEVICE, RECEPTION METHOD, AND TRANSMISSION METHOD

(71) Applicant: Panasonic Corporation, Osaka (JP)

(72) Inventors: Hiroshi Yahata, Osaka (JP); Tomoki Ogawa, Osaka (JP)

(21) Appl. No.: 14/232,052

(22) PCT Filed: May 7, 2013
(86) PCT No.: PCT/JP2013/002929

§ 371 Date: Jan. 10, 2014

Related U.S. Application Data
(60) Provisional application No. 61/654,163, filed on Jun. 1, 2012.
(60) Provisional application No. 61/651,214, filed on May 24, 2012.

(51) Int. Cl. H04N 21/4402; H04N 13/00; H04N 21/2343

(52) U.S. Cl. CPC H04N 21/440218; H04N 21/234309; H04N 13/0059; H04N 13/0029
USPC 725/110; 725/116

(57) ABSTRACT

A reception device receives program data transmitted by an outside transmission device, and comprises: an information storage unit storing first information that includes processing capability information for playing back the program data and user preference information relating to a viewing mode for programming; an information reception unit receiving second information that is associated with a program and indicates a condition for determining the viewing mode for programming; a determination unit using the first information stored in the information storage unit and the second information received by the information reception unit to make a determination of the viewing mode for programming associated with the second information; and a decoded output unit decoding and outputting the program data of the program associated with the second information, in the viewing mode determined by the determination unit.

### TECHNICAL FIELD

The present disclosure pertains to technology for transmitting and receiving television program data.

### BACKGROUND ART

Conventionally, digital television programs are broadcast within North America in conformity with the Advanced Television Systems Committee Standards (hereinafter, ATSC standards) (see Non-Patent Literature 1).

However, programs in a viewing mode that differs from the viewing mode in the conventional standards (hereinafter termed a new viewing mode) are being experimentally broadcast (e.g., 3D programs, 4K2K high-definition programs, and so on).

A reception device conforming to playback standards for playing back a program in the new viewing mode plays back the program in the new viewing mode upon receiving a signal therefor.

### CITATION LIST

### Non-Patent Literature

### [Non-Patent Literature 1]

ATSC Standard: Program and System Information Protocol for Terrestrial Broadcast and Cable (PSIP) Document A/65:2009

### [Non-Patent Literature 2]

ISO/IEC 13818-1 Information technology—Generic coding of moving pictures and associated audio information: Systems

### SUMMARY OF INVENTION

### Technical Problem

However, a reception device without processing capability conforming to the playback standards for the new viewing mode is unable to play back the program in the new viewing mode, despite receiving signals therefor. The reception device is not only unable to play back the program in the new viewing mode, but may also attempt to play back the program in a manner that is displeasing to the user of the reception device.

In consideration of this problem, the present disclosure aims to provide a reception device that is compatible with a transmission and reception method for controlling playback in an appropriate viewing mode.

### Solution to Problem

In order to solve the above-described problem, the present disclosure provides a reception device receiving program data transmitted by an outside transmission device, and comprising: an information storage unit storing first information that includes processing capability information for playing back the program data and user preference information relating to a viewing mode for programming; an information reception unit receiving second information that is associated with a program and indicates a condition for determining the viewing mode for programming; a determination unit using the first information stored in the information storage unit and the second information received by the information reception unit to make a determination of the viewing mode for programming associated with the second information; and a decoded output unit decoding and outputting the program data of the program associated with the second information, in the viewing mode determined by the determination unit.

### Advantageous Effects of Invention

According to this configuration, the reception device is able to determine a viewing mode for a program in an environment where information indicating a condition for determining the viewing mode of the program broadcast by a broadcaster. This enables playback control to be performed in a manner suited to the viewing mode.

### BRIEF DESCRIPTION OF DRAWINGS

FIG. 1 is a schematic diagram of a broadcasting system 100.

FIG. 2 is a schematic diagram of a broadcasting station 110.

FIG. 3 is a data configuration diagram for a dcc_selection_id field.

FIG. 4 is an assignment table for a dcc_selection_type field.

FIG. 5 is a timing chart for a program group broadcast by the broadcasting station 110.

FIG. 6 is a configuration diagram of an STB 120.

FIG. 7 is a data configuration diagram for DCCRR 3D data.

FIG. 8 is a truth table for a logical operation performed using base units.

FIG. 9 is a flowchart of a determination process.

FIG. 10 is a flowchart of a forced selection determination process.

FIG. 11 is a flowchart of a recommended selection determination process.

FIG. 12 is a flowchart of a sub-condition determination process.

FIG. 13 is a timing chart for message display.

FIG. 14 is a schematic diagram of a broadcasting station 1410.

FIG. 15 is a data configuration diagram for a dcc_selection_id field.

FIG. 16 is a configuration diagram of an STB 1620.

FIG. 17 is a data configuration diagram for DCCRR UHD data.

FIG. 18 is a schematic diagram of a broadcasting station 1810.

FIG. 19 is a data configuration diagram of a master guide table (hereinafter, MGT).

FIG. 20 is a data configuration diagram of a terrestrial virtual channel table (hereinafter, TVCT).

FIG. 21 is a data configuration diagram of a cable virtual channel table (hereinafter, CVCT).

FIG. 22 is a data configuration diagram of an event information table (hereinafter, EIT).

FIG. 22 is a data configuration diagram of an extended text table.

FIG. 24 is a data configuration diagram of a service_location_descriptor field.

FIG. 25 is a schematic diagram indicating the relationship between the MGT, the VCT, and the EIT.

FIG. 26 is a schematic diagram indicating the relationship between the MGT, the VCT, and the EIT.

FIG. 27 is a configuration diagram of an STB 2700.

FIG. 28 is a configuration diagram of an STB 2800.

FIG. 29 is a schematic diagram indicating the relationship between the MGT, the VCT, and the EIT.

FIG. 30 is a schematic diagram of a broadcasting station 3010.

FIG. 31 is a configuration diagram of an STB 3100.

FIG. 32 is a flowchart of a variant determination process.

FIG. 33 is a configuration diagram of a reception device 3300.

### DESCRIPTION OF EMBODIMENTS

### Embodiment 1

(Overview)

The inventors realised that a reception device without processing capability conforming to a playback standard for playing back a 3D program is not only unable to play back a received 3D program but also performs playback in a viewing format that is not beneficial for the user of the reception device. For example, when a reception device conforming to conventional ATSC standards but not conforming to a 3D playback standard for playing back a 3D program in side-by-side format receives a 3D program in the side-by-side format, the reception device plays back the program by displaying left-view video in the left-hand half of the screen and displaying right-view video in the right-hand half of the screen.

The inventors also realised that some users of a reception device possessing processing capability conforming to the playback standard for playing back a 3D program prefer 2D programs to 3D programs.

The inventors then arrived at a method for transmitting and receiving programs enabling playback of programs in an appropriate format suited to the processing capability for playback of a program playback system that includes the reception device, to the viewing format preferences of the reception device user, and to the intent of the program broadcaster.

One aspect of the reception device pertaining to the present disclosure is described below, in terms of a broadcasting system made up of a broadcasting station transmitting a 3D program over the Internet and using broadcast waves to transmit a 2D program corresponding to the 3D program, and a set top box (hereinafter, STB) serving as a reception device receiving the 3D program and the 2D program transmitted by the broadcasting station.

In this broadcasting system, the broadcasting station transmits the 3D program and the 2D program by not only transmitting the programs but also making a request to the STB for information indicating 3D program playback requirements (hereinafter, playback requirement information). Meanwhile, the STB stores information indicating the processing capability for playing back the 3D program within the program playback system (hereinafter, processing capability information).

Upon receiving the playback requirement information associated with the 3D program transmitted by the broadcasting station, the STB uses a 64-bit dcc_selection_id field (described in detail later) of the playback requirement information and DCC capable DTV reference receiver (hereinafter, DCCRR) 3D data (described in detail later) of the processing capability information stored by the STB to perform a logical operation. The STB then uses the result of the logical operation to determine whether the playback target is to be the 3D program associated with the playback requirement information or the 2D program corresponding to the 3D program. Then, once the 3D program and the 2D program are transmitted from the broadcasting station, the STB selects the program determined as the playback target and performs a decoding process thereon.

The respective configurations of the STB and of the broadcasting station transmitting the program are described below, with reference to the accompanying drawings.

(Configuration)

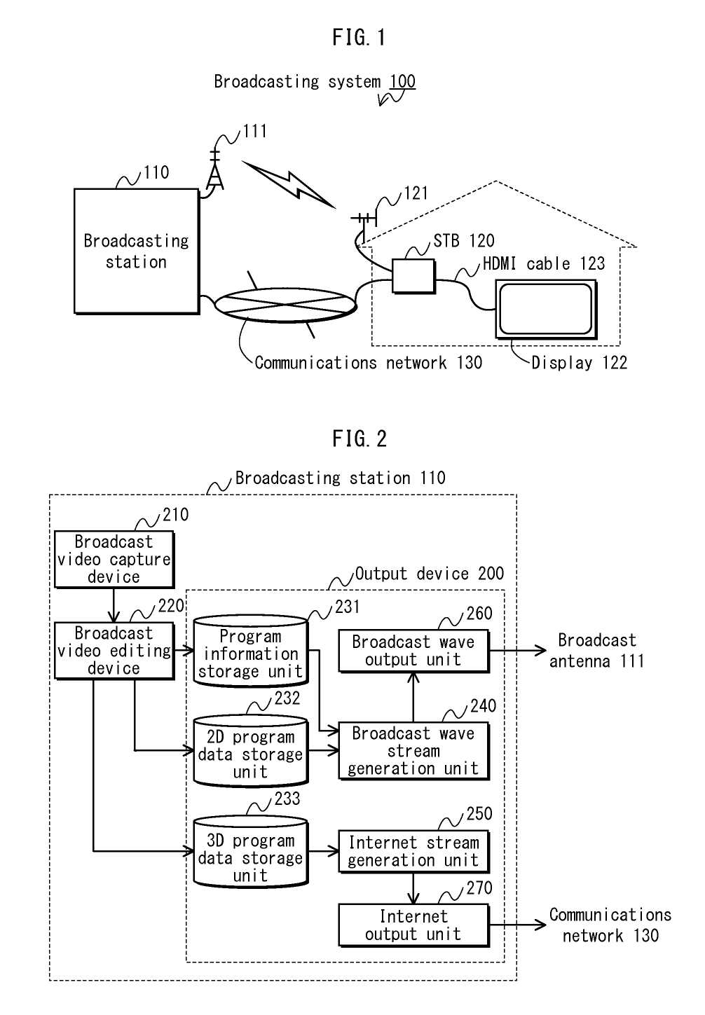

FIG. 1 schematically depicts a broadcasting system 100 including a broadcasting station 110 and an STB 120.

As shown, the broadcasting station 110 performs parallel transmission of a 2D program conforming to extended ATSC standards, in which channel information has been partially extended from conventional ATSC standards, and a 3D program corresponding to the 2D program (e.g., having the same content as the 2D program but differing in terms of viewing mode). Here, transmitting two programs in parallel signifies that the streams of the programs are transmitted in the same time slot.

The broadcasting station 110 transmits the 2D program and the 3D program in parallel by multiplexing program information corresponding to the 2D and 3D programs (i.e., a Master Guide Table (hereinafter, MGT), a Virtual Channel Table (hereinafter, VCT), an Event Information Table (hereinafter, EIT), and so on; refer to ATSC standards) with data for the 2D program, generating a broadcast wave stream in Motion Picture Experts Group (hereinafter, MPEG)-2 Transport Stream (hereinafter, TS) format, and using broadcast waves from a broadcasting antenna 111 to transmit the generated broadcast wave stream. The broadcasting station 110 then generates an Internet stream in MPEG-2 TS format from the 3D program broadcast data and transmits the generated Internet stream through a communications network 130.

Here, the program information corresponding to the 2D and 3D programs includes playback requirements for the corresponding 3D program.

The STB 120 is connected to a display 122 via a High Definition Multimedia Interface (hereinafter, HDMI™) cable 123, and stores information indicating the 3D program playback requirement for a playback system made up of the STB 120, the HDMI cable 123, and the display 122. The STB uses a receive antenna 121 to receive the broadcast wave stream and uses the communications network 130 to receive the Internet stream.

Upon receiving the broadcast wave stream and the Internet stream, the STB 120 checks whether or not the stored 3D program playback requirement satisfies the 3D program playback requirements in the broadcast wave stream. In the affirmative case, the 3D program data in the Internet stream are decoded. In the negative case, the 2D program data in the broadcast wave stream are decoded.

FIG. 2 indicates the overall configuration of the broadcasting station 110.

As shown, the broadcasting station 110 includes a broadcast video capture device 210, a broadcast video editing device 220, and an output device 200. The output device 200 includes a program information storage unit 231, a 2D program data storage unit 232, a 3D program data storage unit 233, a broadcast wave stream generation unit 240, an Internet stream generation unit 250, a broadcast wave output unit 260, and an Internet output unit 270.

The broadcast video capture device 210 is connected to the broadcast video editing device 220, has a video camera or similar capture instrument, and captures audio and video.

The broadcast video editing device 220 is connected to the broadcast video capture device 210, the program information storage unit 231, the 2D program data storage unit 232, and the 3D program data storage unit 233, includes a computer system having a processor, a memory, and so on, edits the audio and video captured by the broadcast video capture device 210, and generates the 2D program data, the 3D program data, and program information associating the 2D program with the 3D program.

The 2D program data generated by the broadcast video editing device 220 include a 2D video stream and an audio stream for the 2D program, each conforming to conventional ATSC standards. The program information conforms to extended ATSC standards, in which channel information has been partially extended from the conventional ATSC standards. The 3D data include a 3D video stream and an audio stream for the 3D program.

The 3D video stream may be encoded in MPEG-4 Multiview Video Coding (hereinafter, MVC) format.

The 2D program data and the 3D program data are associated with one another by information within the program information (e.g., the EIT).

The program information storage unit 231 is connected to the broadcast video editing device 220 and the broadcast wave stream generation unit 240, includes a hard disk drive or similar storage device, and stores the program information generated by the broadcast video editing device 220.

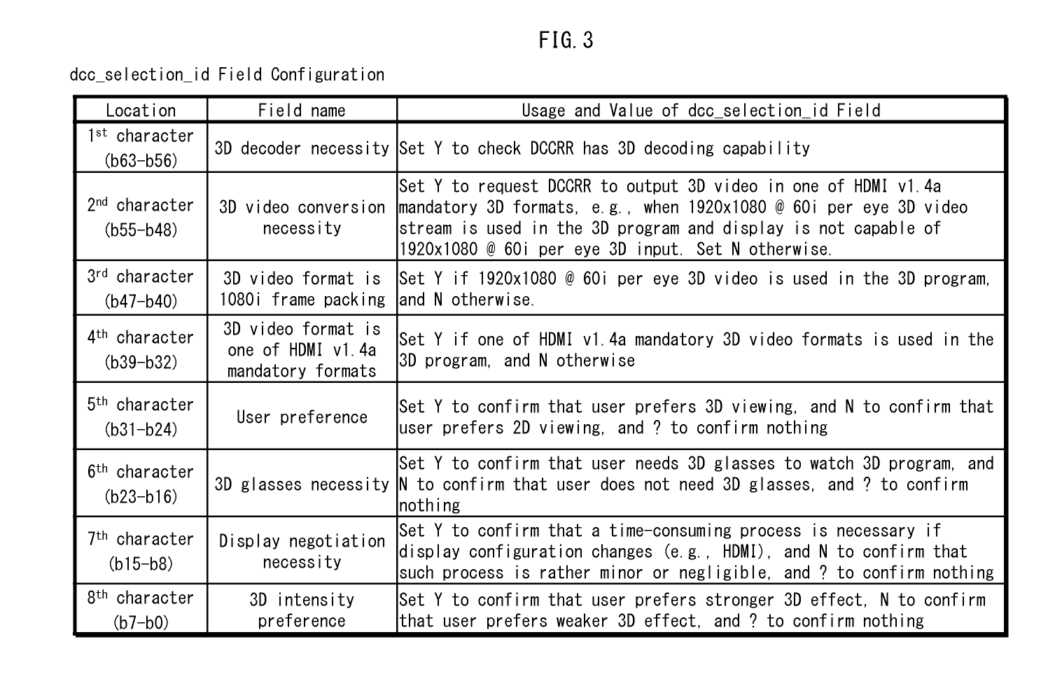

FIG. 3 is a data configuration table showing an example of dcc_selection_id field data configuration, this field being a portion of channel change control information in the program information stored by the program information storage unit 231.

As shown below, the dcc_selection_id field is a bit sequence of information indicating the playback requirement for the request made to the STB when performing 3D program playback.

As indicated in FIG. 3, the dcc_selection_id is a 64-bit sequence configured from eight 1-byte terms.

Among these eight terms, the leading five are respectively associated with five playback requirements of the request made to the STB when performing 3D program playback. Each of these five terms is configurable according to whether or not the playback requirement associated therewith is one of the 3D program playback requirements associated with the program information having the dcc_selection_id field.

The trailing three terms among the eight terms of the dcc_selection_id field are each associated with one of three confirmation requirements to be confirmed by the STB when performing 3D program playback. Each of these three terms is configurable according to whether or not the confirmation requirement associated therewith is one of the 3D program confirmation requirements associated with the program information having the dcc_selection_id field.

The eight terms are described below.

The 3D decoder necessity term is set according to whether or not one of the playback requirements is the decoder having 3D video decoding capability. In the affirmative case, the term is set to ASCII Y. In the negative case, the term is set to ASCII N. When unknown or irrelevant, the term is set to ASCII ?.

The 3D video conversion necessity term is set according to whether or not one of the playback requirements is the decoder being able to convert 3D video into a mandatory 3D format conforming to HDMI v1.4. In the affirmative case, the term is set to ASCII Y. In the negative case, the term is set to ASCII N. When unknown or irrelevant, the term is set to ASCII ?.

Presently, the majority of displays sold as 3D television displays and conforming to the HDMI v1.4a standard are not compatible with 1920×1080 @ 60i per eye frame packing, which is an option in the HDMI v1.4a standard. Accordingly, 3D video in this format must be converted by the decoder.

The 3D Video format is 1080i frame packing term is set according to whether not one of the playback requirements is the display being compatible with 1920×1080 @ 60i per eye as a 3D video format. In the affirmative case, the term is set to ASCII Y. In the negative case, the term is set to ASCII N. When unknown or irrelevant, the term is set to ASCII ?.

The 3D Video format is one of HDMI v1.4a mandatory formats term is set according to whether or not one of the playback requirements is the display being compatible with all HDMI v1.4a mandatory 3D video formats. In the affirmative case, the term is set to ASCII Y. In the negative case, the term is set to ASCII N. When unknown or irrelevant, the term is set to ASCII ?.

The User preference term is set according to whether or not one of the confirmation requirements is that the user of the playback system prefers 3D viewing to 2D viewing. In the affirmative case, the term is set to ASCII Y. In the negative case, the term is set to ASCII N. When unknown or irrelevant, the term is set to ASCII ?.

The 3D glasses necessity term is set according to whether or not one of the confirmation requirements is that the playback system makes wearing 3D glasses a necessity when playing back 3D video. In the affirmative case, the term is set to ASCII Y. In the negative case, the term is set to ASCII N. When unknown or irrelevant, the term is set to ASCII ?.

The Display negotiation necessity term is set according to whether or not one of the confirmation requirements is that changing video formats (e.g., changing from 2D viewing to 3D viewing) requires a relatively time-consuming process (i.e., 5 to 7 seconds). In the affirmative case, the term is set to ASCII Y. In the negative case, the term is set to ASCII N. When unknown or irrelevant, the term is set to ASCII ?.

Typically, when the STB and the display are connected via an HDMI cable, switching the video format from 2D to 3D requires a relatively time-consuming process (i.e., 5 to 7 seconds) before the display actually changes. This field is also used in order to avoid situations such as a portion of a commercial break being undisplayable, by preventing the occurrence of a switch from 2D to 3D through this playback requirement.

The 3D intensity preference term is set according to whether or not one of the confirmation requirements is that the playback system user prefers a relatively strong 3D effect (i.e., a relatively large disparity). In the affirmative case, the term is set to ASCII Y. In the negative case, the term is set to ASCII N. When unknown or irrelevant, the term is set to ASCII ?.

Typically, a display having a comparatively large screen size undergoes a failure to form images when the disparity is relatively large. This term is also used as a playback requirement when intensifying the 3D effect according to the display screen size.

The explanation of the broadcasting station 110 now resumes, with reference to FIG. 2.

The dcc_selection_type field within the channel change control information in the program information stored in the program information storage unit 231 has been partially extended from conventional ATSC standards.

In the conventional ATSC standards, the dcc_selection_type field is defined for values 0x00-0x18, 0x1C, and 0x20-0x23. However, the dcc_selection_type field within the channel change control information in the program information stored in the program information storage unit 231 is additionally defined for values 0x26-0x28.

This newly-defined dcc_selection_type defines a logical operation applied by a determiner 640 (described later) in the STB 120 to realise program playback determination (also described later).

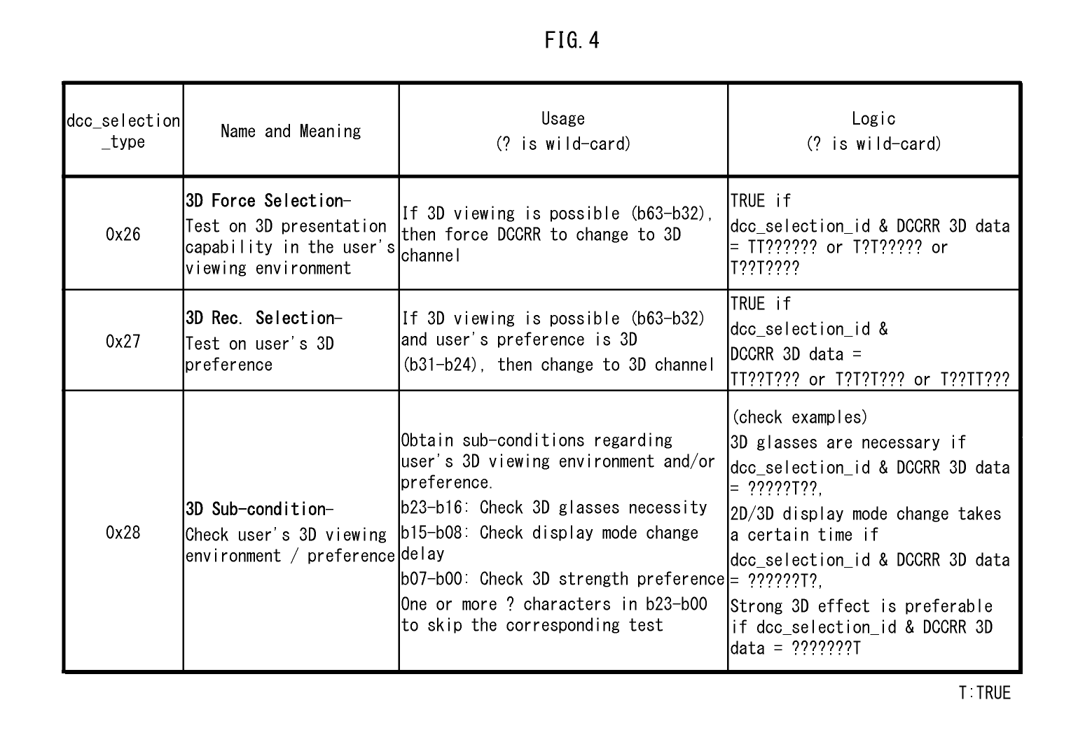

FIG. 4 is an assignment table for the dcc_selection_type field newly-defined within the channel change control information in the program information stored in the program information storage unit 231.

The dcc_selection_type field at 0x26 is a type named 3D Force Selection, and specifies a logical operation performed using the leading four bytes of the aforementioned dcc_selection_id field transmitted from the broadcasting station 110 with the leading four bits of the later-described DCCRR 3D data stored in the STB 120.

Here, the logical operation returns TRUE when the playback system receiving the corresponding 3D program has the processing capability for suitably playing back the 3D program.

For example, this type is selected when the playback system receiving the program information is being forced to play back the 3D program.

The dcc_selection_type field at 0x27 is a type named 3D Rec. Selection, and specifies a logical operation performed using the leading five bytes of the aforementioned dcc_selection_id field transmitted from the broadcasting station 110 with the leading five bits of the later-described DCCRR 3D data stored in the STB 120.

Here, the logical operation returns TRUE when the playback system receiving the corresponding 3D program has the processing capability for suitably playing back the 3D program and the user of the playback system prefers 3D viewing to 2D viewing.

For example, this type is selected when the playback system receiving the program information plays back the 3D program only when the user prefers 3D programs.

The dcc_selection_type field at 0x28 is a type named 3D Sub-Selection, and specifies a logical operation performed using the trailing three bytes of the aforementioned dcc_selection_id field transmitted from the broadcasting station 110 with the trailing three bits of the later-described DCCRR 3D data stored in the STB 120.

This type is selected along with the 3D Force Selection or the 3D Rec. Selection.

For example, this type is selected when the viewing environment of the playback system receiving the program information has been checked in detail for user intention and the like, in order to provide fine-tuned service to that user.

The explanation of the broadcasting station 110 now resumes, with reference to FIG. 2.

The 2D program data storage unit 232 is connected to the broadcast video editing device 220 and the broadcast wave stream generation unit 240, includes a hard disk drive or similar storage device, and stores the 2D program data generated by the broadcast video editing device 220.

The 3D program data storage unit 233 is connected to the broadcast video editing device 220 and the Internet stream generation unit 250, includes a hard disk drive or similar storage device, and stores the 3D program data generated by the broadcast video editing device 220.

The broadcast wave stream generation unit 240 is connected to the program information storage unit 231, the 2D program data storage unit 232, and the broadcast wave output unit 260, includes a computer system having a processor, memory, and the like, and multiplexes the 2D program data stored in the 2D program data storage unit 232 with the program information stored in the program information storage unit 231 to generate a broadcast wave stream in MPEG-2 TS format.

The broadcast wave output unit 260 is connected to the broadcast wave stream generation unit 240 and the broadcasting antenna 111, modulates the broadcast wave stream generated by the broadcast wave stream generation unit 240 into broadcast waves of a predetermined frequency band, and transmits the broadcast waves over the broadcasting antenna 111.

The Internet stream generation unit 250 is connected to the 3D program data storage unit 233 and the Internet output unit 270, includes a computer system having a processor, memory, and the like, and generates an Internet stream in MPEG-2 TS format from the 3D program data stored in the 3D program data storage unit 233.

The Internet output unit 270 is connected to the Internet stream generation unit 250 and to the communications network 130, and outputs the Internet stream generated by the Internet stream generation unit 250 through the communications network 130.

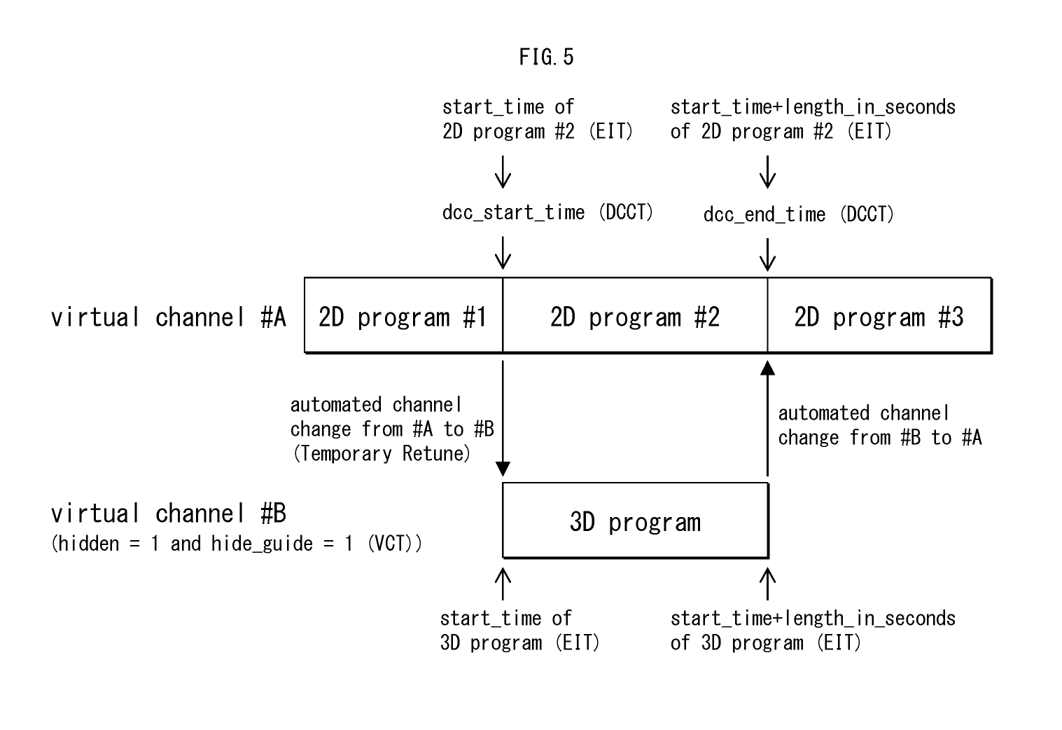

FIG. 5 is a timer chart for a group of programs broadcast by the broadcasting station 110.

As shown, this example has 2D program #1, 2D program #2, and 2D program #3 sequentially broadcast over virtual channel #A. Also, a 3D program corresponding to 2D program #2 is broadcast over virtual channel #B during the time slot for 2D program #2.

Here, the virtual channel #B is registered in the VCT as hidden=1, hide_guide=1. This is done so that the user of the STB 120 is not aware of virtual channel #B (i.e., a channel not displayed in the Electronic Program Guide (hereinafter, EPG) cannot be inadvertently selected by the user).

Also, although the 3D program in virtual channel #B is described by an EIT unique to virtual channel #B, the program start_time (i.e., start_time field) and program end time (i.e., start_time field+length_in_seconds field) thereof are the same as the respective program start time and program end time of 2D program #2.

Furthermore, a Directed Channel Change Table (hereinafter, DCCT) in the channel change control information is such that the 3D program and 2D program #2 have the same start time (i.e., the dcc_start_time field) and end time (i.e., the dcc_end_time field) for channel change control.

In this example, the channel change control information uses the temporary retune mode (i.e., dcc_context=0). In the temporary retune mode, the reception device performs an automatic channel change from virtual channel #A to virtual channel #B in accordance with the conditions set in the dcc_start_time field, then performs another automatic channel change to revert to the original channel (i.e., virtual channel #A) in accordance with the dcc_end_time field. For example, this mode is used to automatically perform the selection of a 2D or 3D program according to the given conditions when the 2D and 3D programs are divided among channels.

When the temporary retune mode is not used, a channel redirect mode is employed to change the channel once, without assuming reversion to the original channel. For example, this mode may be used at the beginning and end of the program to cause the reception device to perform similar operations to the temporary retune mode.

Here, virtual channel #A and virtual channel #B may be transported as a common TS, or as separate TS. When separate TS are used, basic blocks such as the program clock reference (hereinafter, PCR) are beneficially made to match between the two TS so as to reduce the necessary processing when changing channels. Also, when the PCR is synchronised, the reception device is beneficially informed of such in a new descriptor or the like within the Program Specific Information (hereinafter, PSI)/Service Information (hereinafter, SI) of the base channel TS (e.g., the TS in the virtual channel #A).

When virtual channel #A and virtual channel #B differ in terms of video encoding format (e.g., MPEG-2 for virtual channel #A and MPEG-4 MVC for virtual channel #B), a closed group of pictures (hereinafter, GOP) structure is generally employed immediately after the dcc_end_time field (or immediately after the end of 2D program #2, or at the beginning of 2D program #3) so as to enable video playback as soon as the change from virtual channel #B to virtual channel #A is performed at the dcc_end_time field. A closed GOP structure is one in which all pictures in the GOP, which is an encoded sequence unit beginning with an I-picture, are decodable by beginning the decoding with the leading I-picture of the GOP (i.e., all reference pictures are included in the GOP).

Similarly, the paired 2D program #2 and 3D program beneficially have a respective GOP boundary (i.e., an I-picture having the Presentation Time Stamp (hereinafter, PTS) immediately following the start time and end time) at the start time and end time, so as to reduce the necessary processing when changing the channel.

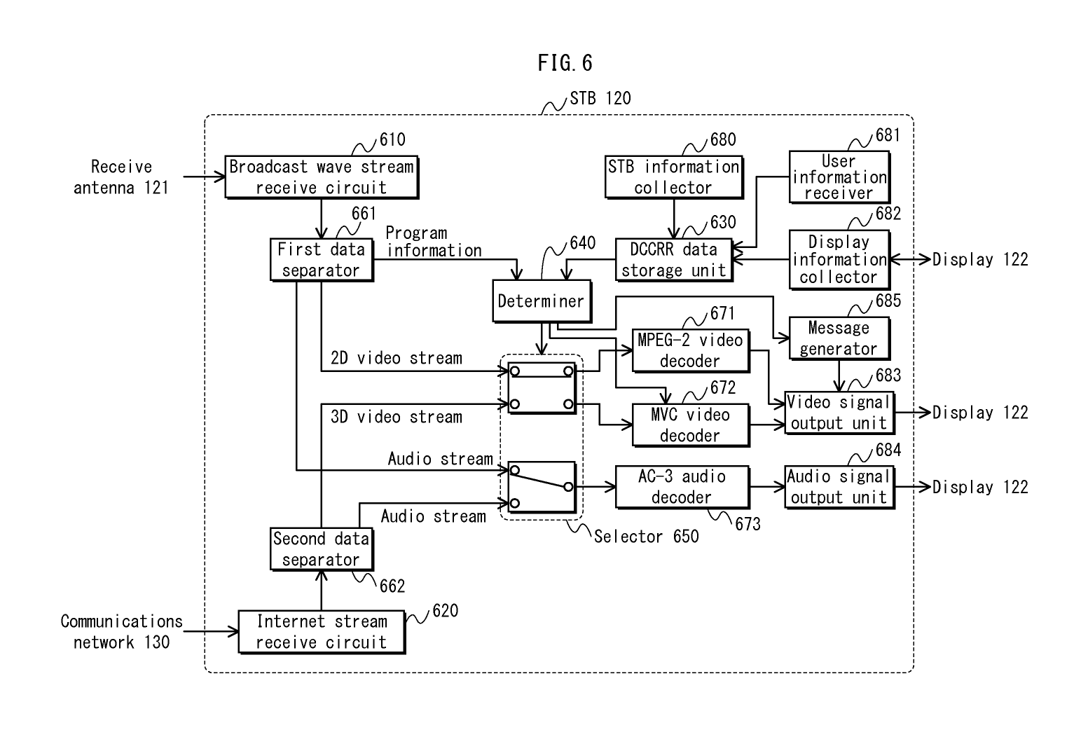

FIG. 6 indicates the overall configuration of the STB 120.

As shown, the STB 120 includes a broadcast wave stream receive circuit 610, an Internet stream receive circuit 620, a first data separator 661, a second data separator 662, a determiner 640, a selector 650, a DCCRR data storage unit 630, an MPEG-2 video decoder 671, an MVC video decoder 672, an AC-3 audio decoder 673, an STB information collector 680, a user information receiver 681, a display information collector 682, a message generator 685, a video signal output unit 683, and an audio signal output unit 684.

The broadcast wave stream receive circuit 610 is connected to the receive antenna 121 and the first data separator 661, uses the receive antenna 121 to receive the broadcast waves transmitted by the broadcasting station 110, then demodulates the received broadcast waves to generate a broadcast wave stream for output.

The Internet stream receive circuit 620 is connected to the communications network 130 and the second data separator 662, and receives the Internet stream transmitted by the broadcasting station through the communications network 130 for output.

The first data separator 661 is connected to the broadcast wave stream receive circuit 610, the determiner 640, and the selector 650, and separates the broadcast wave stream output by the broadcast wave stream receive circuit 610 into program information, a 2D video stream, and an audio stream for output.

The second data separator 662 is connected to the Internet stream receive circuit 620 and the selector 650, and separates the Internet stream output by the Internet stream receive circuit 620 into a 3D video stream and an audio stream for output.

The DCCRR data storage unit 630 is connected to the determiner 640, the STB information collector 680, the user information receiver 681, and the display information collector 682, includes flash memory or similar, and stores 64-bit DCCRR 3D data.

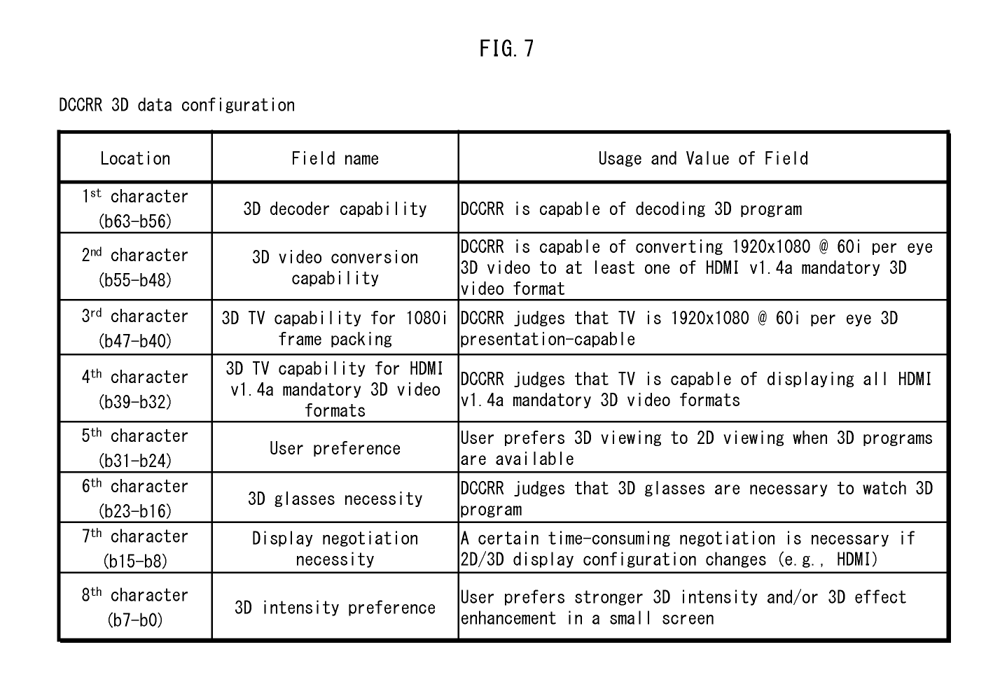

FIG. 7 is a data configuration table showing an example of the DCCRR 3D data stored in the DCCRR data storage unit 630.

As shown below, the DCCRR 3D data is a bit sequence of information indicating the processing capability of the playback system for performing program playback.

As indicated in FIG. 7, the DCCRR 3D data is a 64-bit sequence configured from eight 1-byte fields.

Each of these eight fields corresponds to one of the eight terms making up the dcc_selection_id field (see FIG. 3) which is a part of the channel change control information in the program information transmitted by the broadcasting station 110. Each of these eight fields indicates the presence or absence of a processing capability for playing back a program or indicates a user preference, with relevance to the playback system.

The eight fields are described below.

The 3D decoder capability term indicates whether or not the device is capable of decoding 3D video. In the affirmative case, the term is set to ASCII Y. In the negative case, the term is set to ASCII N. When unknown, the term is set to ASCII ?.

The 3D video conversion capability term indicates whether or not the device is capable of converting 3D video into one of the mandatory 3D formats defined by the HDMI v1.4a specification. In the affirmative case, the term is set to ASCII Y. In the negative case, the term is set to ASCII N. When unknown, the term is set to ASCII ?.

The 3D TV capability for 1080i frame packing term indicates whether or not the display connected to the device is capable of using the 1920×1080 @ 60i per eye frame packing format. In the affirmative case, the term is set to ASCII Y. In the negative case, the term is set to ASCII N. When unknown, the term is set to ASCII ?.

The 3D TV capability for HDMI v1.4a mandatory 3D video formats term indicates whether or not the display connected to the device is compatible with all HDMI v1.4a mandatory 3D video formats. In the affirmative case, the term is set to ASCII Y. In the negative case, the term is set to ASCII N. When unknown, the term is set to ASCII ?.

The user preference term indicates whether or not the user of the device has indicated a preference for 3D viewing over 2D viewing. In the affirmative case, the term is set to ASCII Y. In the negative case, the term is set to ASCII N. When unknown, the term is set to ASCII ?.

The 3D glasses necessity term indicates whether or not the display connected to the device requires that 3D glasses be word when viewing 3D video being played back by the playback system. In the affirmative case, the term is set to ASCII Y. In the negative case, the term is set to ASCII N. When unknown, the term is set to ASCII ?.

The display negotiation necessity term indicates whether or not the display connected to the device in the playback system requires a relatively time-consuming process (i.e., 5 to 7 seconds) when changing video formats (e.g., changing from 2D viewing to 3D viewing). In the affirmative case, the term is set to ASCII Y. In the negative case, the term is set to ASCII N. When unknown, the term is set to ASCII ?.

The 3D intensity preference term indicates whether or not the playback system user prefers a relatively strong 3D effect (i.e., a relatively large disparity). In the affirmative case, the term is set to ASCII Y. In the negative case, the term is set to ASCII N. When unknown, the term is set to ASCII ?.

Returning to FIG. 6, the explanation of the STB 120 configuration resumes.

The STB information collector 680 is connected to the DCCRR data storage unit 630 and sets the 3D decoder capability and the 3D video conversion capability terms in the DCCRR 3D data stored in the DCCRR data storage unit 630 according to the decoding and format conversion capabilities of the device.

The user information receiver 681 is connected to the DCCRR data storage unit 630, includes a remote control or similar for receiving operations from the user, and sets the user preference and 3D intensity preference terms in the DCCRR 3D data stored in the DCCRR data storage unit 630 in accordance with a received user operation.

The display information collector 682 is connected to the DCCRR data storage unit 630 and to the display 122 via the HDMI cable 123, collects information by communicating with the display 122, and sets the 3D TV capability for 1080i frame packing term, the 3D TV capability for HDMI v1.4a mandatory 3D video formats term, the 3D glasses necessity term, and the display negotiation necessity term according to the DCCRR 3D data stored in the DCCRR data storage unit 630.

The determiner 640 is connected to the first data separator 661, the DCCRR data storage unit 630, the selector 650, the MVC video decoder 672, and the message generator 685, includes a processor for executing a program and a memory or similar for storing the program, and realises the following three functions by having the processor execute the program.

Playback Program Determination: When program information from the data separator 661 has been separated and output, and the program information includes a dcc_selection_type field with a value of 0x26, 0x27, or 0x28, applying a logical operation associated with the dcc_selection_type field using the dcc_selection_id field in the program information and the DCCRR 3D data stored in the DCCRR data storage unit 630, then determining whether to play back the 2D program or the 3D program according to the results of the logical operation.

3D Intensity Adjustment: When the previous logical operation has been applied and the results thereof indicate that the 3D intensity should be strong, outputting a signal instructing the MVC video decoder 672 to produce strong 3D intensity.

Message Instruction: When the previous logical operation has been applied and the results indicate that a message is required to be shown on the display, outputting a signal instructing the message generator 685 to output such a message.

Here, the logical operation performed by the determiner 640 is performed on the base units making up the dcc_selection_id field and the corresponding units making up the DCCRR 3D data.

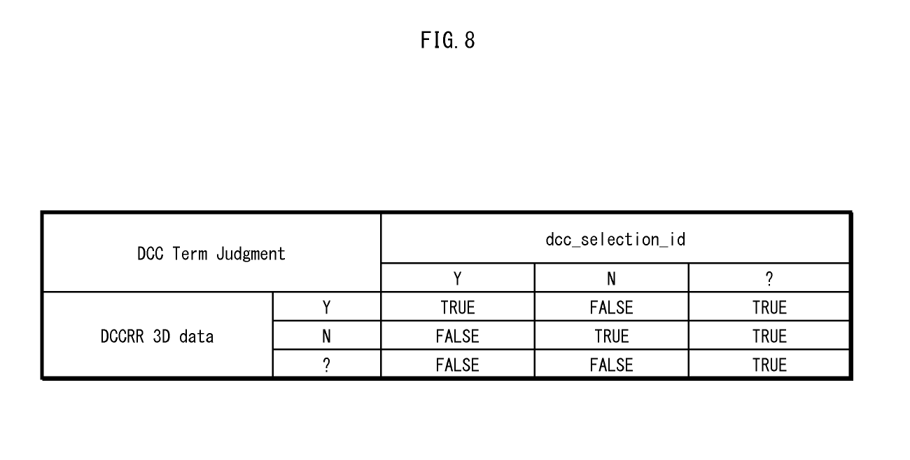

FIG. 8 shows an example of a truth table used when performing the logical operation.

As shown, the logical operation performed using the base units returns TRUE when: (1) the dcc_selection_id field and the corresponding DCCRR 3D data field both read Y; (2) the dcc_selection_id field and the corresponding DCCRR 3D data field both read N; and (3) the dcc_selection_id field reads ?, and returns FALSE otherwise.

The logical operation performed by the determiner 640 is described in further detail below, in the Determination Process section. Specific examples are also discussed in the Forced Selection Determination Process, Recommended Selection Determination Process, and Sub-Condition Determination Process sections.

Returning to FIG. 6, the explanation of the STB 120 configuration resumes.

The selector 650 is connected to the first data separator 661, the second data separator 662, the determiner 640, the MPEG-2 video decoder 671, the MVC video decoder 672, and the AC-3 audio decoder 673, and performs the following two functions.

Video Stream Selection: When the determiner 640 has determined which of the 2D program and the 3D program to play back, the 2D video stream of the 2D program is output from the first data separator 661, and the 3D video stream of the 3D program is output from the second data separator 662: (1) selecting the 2D video stream for output to the MPEG-2 video decoder 671 when the 2D program has been determined; and (2) selecting the 3D video stream for output to the MVC video decoder 672 when the 3D program has been determined.

Audio Stream Selection: When the determiner 640 has determined which of the 2D program and the 3D program to play back, the audio stream of the 2D program is output from the first data separator 661, and the audio stream of the 3D program is output from the second data separator 662: (1) selecting the audio stream being output by the first data separator 661 for output to the AC-3 audio decoder 673 when the 2D program has been determined; and (2) selecting the audio stream being output by the second data separator 662 for output to the AC-3 audio decoder 673 when the 3D program has been determined.

The MPEG-2 video decoder 671 is connected to the selector 650 and the video signal output unit 683, and generates a video frame group by decoding the 2D video stream encoded in MPEG-2 format.

The MVC video decoder 672 is connected to the selector 650, the video signal output unit 683, and the determiner 640, and generates a video frame group by decoding the 3D video stream encoded in MPEG-4 MVC format.

When the determiner 640 has transmitted a signal for strong 3D intensity, the MVC video decoder 672 decodes the 3D video stream so as to produce a large disparity, and thus generates video frames with strong 3D intensity.

The AC-3 audio decoder 673 is connected to the selector 650 and to the audio signal output unit 684, and generates audio data by decoding an audio stream.

The message generator 685 is connected to the determiner 640 and the video signal output unit 683, generates message data when the determiner 640 transmits a signal instructing that a message is to be output, and outputs the message data to the video signal output unit 683.

The video signal output unit 683 is connected to the MPEG-2 video decoder 671, the MVC video decoder 672, the message generator 685, and the display 122 via the HDMI cable 123, and outputs video frame groups generated by the MPEG-2 video decoder 671 or by the MVC video decoder 672 to the display 122. Upon receiving message data transmitted by the message generator 685, the video signal output unit 683 superposes the message data over the video frames.

The audio signal output unit 684 is connected to the AC-3 audio decoder 673 and to the display 122 via the HDMI cable 123, and outputs audio data generated by the AC-3 audio decoder 673 to the display 122.

The operations of the STB 120, configured as described above, are described below with reference to the accompanying drawings.

(Operations)

When the STB 120 receives the broadcast wave stream and the Internet stream transmitted by the broadcasting station 110, the STB 120 performs characteristic operations of determining whether to play back the 2D program in the broadcast wave stream or the 3D program in the Internet stream by performing a determination process according to the program information in the broadcast wave stream and the DCCRR 3D data stored in the STB 120 itself.

The determination process is described below.

(Determination Process)

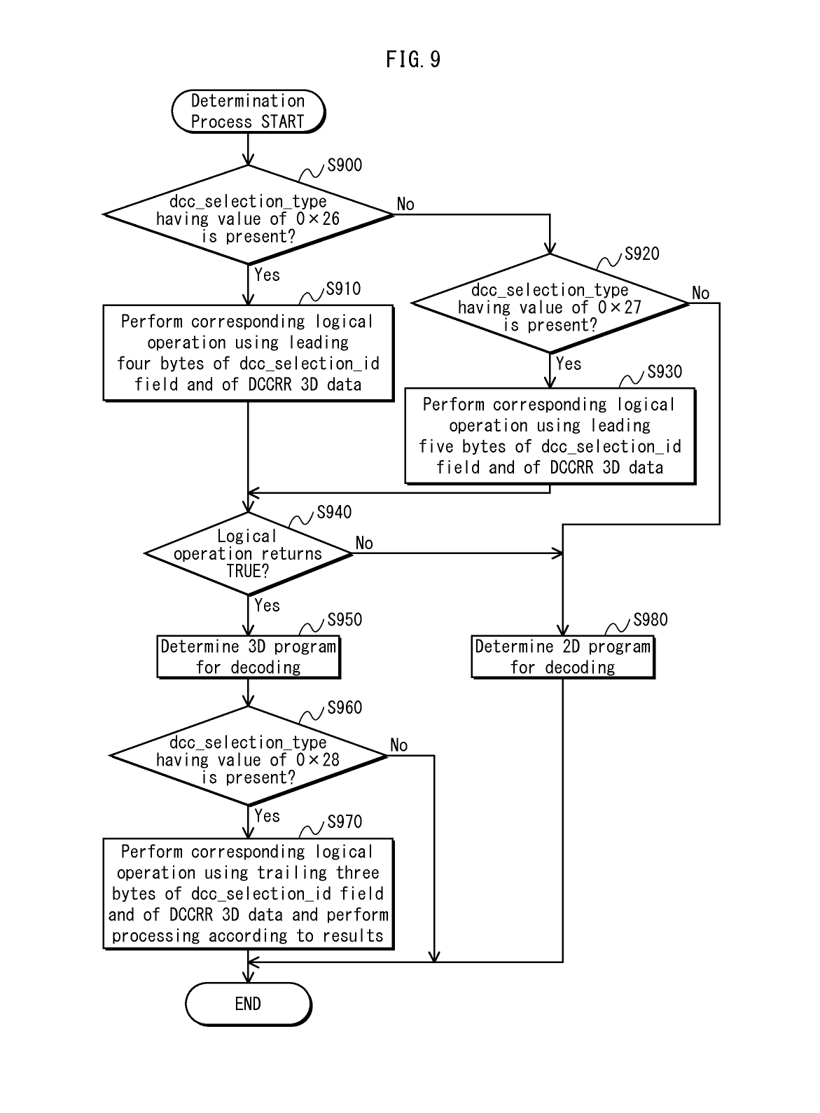

FIG. 9 is a flowchart of the determination process.

The determination process begins when the program information is separated and output from the first data separator 661 to the determiner 640.

Once the determination process starts, the determiner 640 checks whether or not a dcc_selection_type field having a value of 0x26 is present in the program information output by the first data separator 661 (step S900).

In the affirmative case (Yes in step S900), the determiner 640 uses the leading four bytes of the dcc_selection_id field and the leading four bytes of the DCCRR 3D data stored in the DCCRR data storage unit 630 to execute a logical operation associated with the case dcc_selection_type=0x26 (step S910).

In the negative case (No in step S900), the determiner 640 checks whether or not the dcc_selection_type field having a value of 0x27 is present in the program information output by the first data separator 661 (step S920).

In the affirmative case (Yes in step S920), the determiner 640 uses the leading five bytes of the dcc_selection_id field and the leading five bytes of the DCCRR 3D data stored in the DCCRR data storage unit 630 to execute a logical operation associated with the case dcc_selection_type=0x27 (step S930).

When either of step S910 or step S930 is completed, the determiner 640 checks whether the executed logical operation has returned a result of TRUE (step S940).

In the affirmative case (Yes in step S940), the determiner 640 determines that the 3D program in the Internet stream is to be played back (step S950). The determiner 640 then checks whether or not a dcc_selection_type field having a value of 0x28 is present in the program information output by the first data separator 661 (step S960).

In the affirmative case (Yes in step S960), the determiner 640 uses the trailing three bytes of the dcc_selection_id field and the trailing three bytes of the DCCRR 3D data stored in the DCCRR data storage unit 630 to execute a logical operation associated with the case dcc_selection_type=0x28 (step S970).

However, when the result of step S920 or step S940 is negative (No in step S920 or in step S940), the determiner 640 determines that the 2D program in the broadcast wave stream is to be played back (step S980).

When the result of step S960 or step S980 is negative (No in step S960 or in step S980), the STP 120 ends the determination process.

Specific examples of the processing performed in steps S910, S920, and S970 of the determination process are discussed below, with reference to the accompanying drawings.

(Forced Selection Determination Process)

The processing of step S910 is an forced selection determination process performed as part of the determination process when the leading four bytes of the dcc_selection_id field in the program information transmitted by the broadcasting station 110 are all set to Y, i.e. when the 3D decoder necessity term, the 3D Video conversion necessity term, the 3D Video format is 1080i frame packing term, and the 3D Video format is one of HDMI v1.4a mandatory formats term are all set to Y.

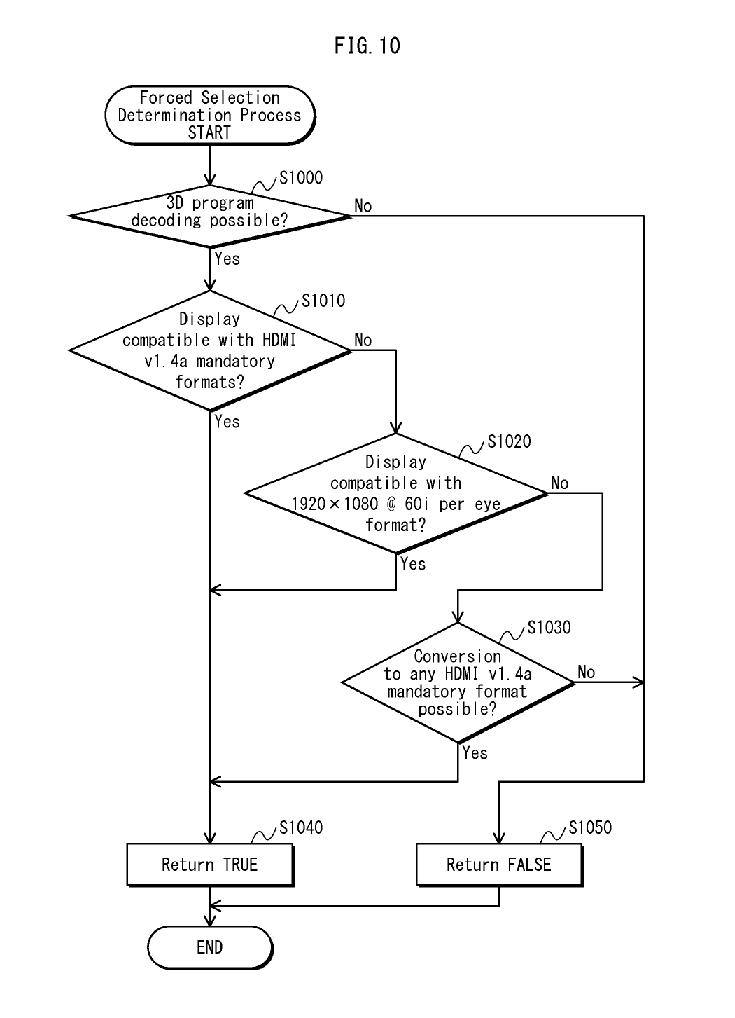

FIG. 10 is a flowchart of the forced selection determination process.

Once the forced selection determination process starts, the determiner 640 performs a logical operation on the base units of the 3D decoder necessity term within the dcc_selection_id field and the 3D decoder capability term in the DCCRR 3D data to determine whether or not the device has the capability to decode 3D video (step S1000). Specifically, the determination is made such that the device is capable of decoding 3D video when the logical operation returns a TRUE result, and such that the device is not capable of decoding 3D video when the logical operation returns a FALSE result.

In the affirmative case (Yes in step S1000), the determiner proceeds to check whether or not the display connected to the device is compatible with all mandatory 3D video formats for HDMI v1.4a by performing a logical operation on the base units of the 3D Video format is one of HDMI v1.4a mandatory formats term within the dcc_selection_id field and on the 3D TV capability for HDMI v1.4a mandatory 3D video formats term in the DCCRR 3D data (step S1010). Specifically, the determination is such that the device is compatible when the logical operation returns a TRUE result, and is not compatible when the logical operation returns a FALSE result.

In the negative case (No in step S1010), the determiner 640 checks whether or not the display connected to the device is compatible with the 1920×1080 @ 60i per eye frame packing method by performing a logical operation on the base units of the 3D video format is 1080i frame packing term within the dcc_selection_id term and on the 3D TV capability for 1080i frame packing field of the DCCRR 3D data (step S1020). Specifically, the determination is such that the device is compatible when the logical operation returns a TRUE result, and is not compatible when the logical operation returns a FALSE result.

In the negative case (No in step S1020), the determiner 640 checks whether or not the device is capable of converting the mandatory 3D video formats for HDMI v1.4a by performing a logical operation on the base units of the 3D video conversion necessity term in the dcc_selection_id field and the 3D video conversion capability term of the DCCRR 3D data (step S1030). Specifically, the determination is such that the device is capable when the logical operation returns a TRUE result, and is not capable when the logical operation returns a FALSE result.

When the result of any of steps S1010, S1020, and S1030 is affirmative (Yes in step S1010, S1020, or S1030), the determiner 640 determines that the result of the logical operation in the forced selection determination process is TRUE (step S1040).

Likewise, when the result of step S1000 or of step S1030 is negative (No in step S1000 or S1030), the determiner 640 determines that the result of the logical operation in the forced selection determination process is FALSE (step S1050).

The determiner 640 ends the forced selection determination process when the process of step S1040 or of step S1050 ends.

(Recommended Selection Determination Process)

The processing of step S930 is a recommended selection determination process performed as part of the determination process when the leading five bytes of the dcc_selection_id field in the program information transmitted by the broadcasting station 110 are all set to Y, i.e. when the 3D decoder necessity term, the 3D Video conversion necessity term, the 3D Video format is 1080i frame packing term, the 3D Video format is one of HDMI v1.4a mandatory formats term, and the User preference term are all set to Y.

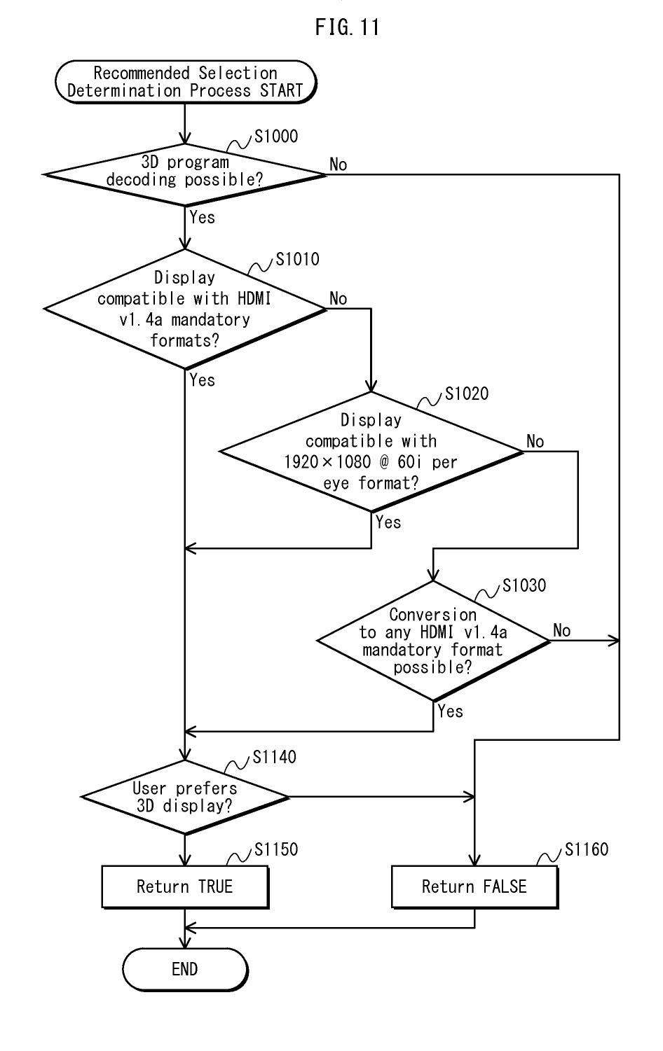

FIG. 11 is a flowchart of the recommended selection determination process.

As shown, the recommended selection determination process is similar to the forced selection determination process (see FIG. 10), differing only in that steps S1040 and S1050 have been removed while steps S1140, S1150, and S1160 have been added. Accordingly, the following explanation is focused on steps S1140, S1150, and S1160.

When the result of any of steps S1010, S1020, and S1030 is affirmative (Yes in step S1010, S1020, or S1030), the determiner 640 checks whether or not the user prefers 3D viewing to 2D viewing by performing a logical operation on the base units of the User preference term in the dcc_selection_id field and the User preference term in the DCCRR 3D data (step S1140). Specifically, the determination is such that the user prefers 3D viewing when the logical operation returns a TRUE result, and does not prefer 3D viewing when the logical operation returns a FALSE result.

In the affirmative case (Yes in step S1140), the determiner 640 determines that the result of the logical operation in the recommended selection determination process is TRUE (step S1150).

Likewise, when the result of step S1000, step S1030, or step S1140 is negative (No in step S1000, S1030, or S1140), the determiner 640 determines that the result of the logical operation in the recommended selection determination process is FALSE (step S1160).

The determiner 640 ends the recommended selection determination process when the process of step S1150 or of step S1160 ends.

(Sub-Condition Determination Process)

The processing of step S970 is a sub-condition determination process performed as part of the determination process when the trailing three bytes of the dcc_selection_id field in the program information transmitted by the broadcasting station 110 are all set to Y, i.e. when the 3D glasses necessity term, the Display negotiation necessity term, and the 3D intensity preference term are all set to Y.

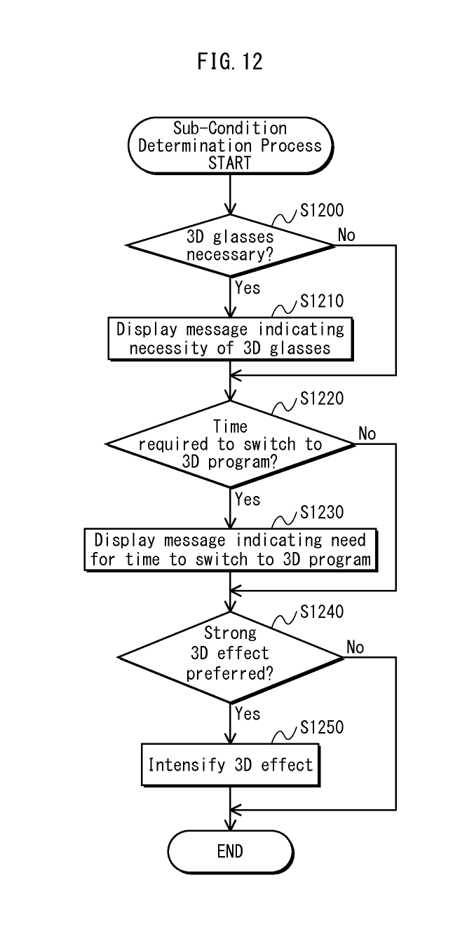

FIG. 12 is a flowchart of the sub-condition determination process.

Once the sub-condition determination process starts, the determiner 640 checks whether or not 3D glasses are necessary for viewing 3D video by performing a logical operation on the base units of the 3D glasses necessity term within the dcc_selection_id field and the 3D glasses necessity term of the DCCRR 3D data (step S1200). Specifically, the determination is such that 3D glasses are necessary when the logical operation returns a TRUE result, and are not necessary when the logical operation returns a FALSE result.

In the affirmative case (Yes in step S1200), the determiner 640 outputs a signal to the message generator 265 to the effect that a message indicating the necessity of 3D glasses is to be displayed when switching the program being played back from a 2D program to the 3D program (step S1210). The message generator 685 then outputs the message indicating the necessity of 3D glasses to the video signal output unit 683 when the program is being switched from the 2D program to the 3D program. The video signal output unit 683 superposes the message indicating the necessity of 3D glasses on a video frame at the appropriate time.

When step S1210 ends, or when the result of step S1200 is negative (No in step S1200), the determiner 640 checks whether or not changing video formats from 2D viewing to 3D viewing requires a relatively time-consuming process (i.e., 5 to 7 seconds) by performing a logical operation on the base units of the Display negotiation necessity field of the dcc_selection_id field and the Display negotiation necessity field of the DCCRR 3D data (step S1220). Specifically, the determination is such that the relatively time-consuming process is required when the logical operation returns a TRUE result, and is not required when the logical operation returns a FALSE result.

In the affirmative case (Yes in step S1220), the determiner 640 outputs a signal to the message generator 265 to the effect that a relatively time-consuming process is required to change the display is to be shown when switching the program being played back from a 2D program to the 3D program (step S1230). The message generator 685 then outputs the message indicating that the relatively time-consuming negotiation process is required to the video signal output unit 683 when the program is being switched from the 2D program to the 3D program. The video signal output unit 683 superposes the message indicating that the relatively time-consuming negotiation process is required onto a video frame at the appropriate time.

When step S1230 ends, or when the result of step S1220 is negative (No in step S1220), the determiner 640 checks whether or not the user prefers a relatively strong 3D effect by performing a logical operation on the base units of the 3D intensity preference term of the dcc_selection_id field and the 3D intensity preference term of the DCCRR 3D data (step S1240). Specifically, the determination is such that the user prefers a relatively intense 3D effect when the logical operation returns a TRUE result, and does not prefer the relatively intense 3D effect when the logical operation returns a FALSE result.

In the affirmative case (Yes in step S1240), the determiner 640 transmits a signal to the MVC video decoder 672 to the effect that the 3D video stream is to be decoded with an intense 3D effect (step S1250). The MVC video decoder 672 then decodes the 3D video stream so as to produce a large disparity, and thus generates video frames with strong 3D intensity.

When step S1250 has ended or when the result of step S1240 is negative (No in step S1240), the determiner 640 ends the sub-condition determination process.

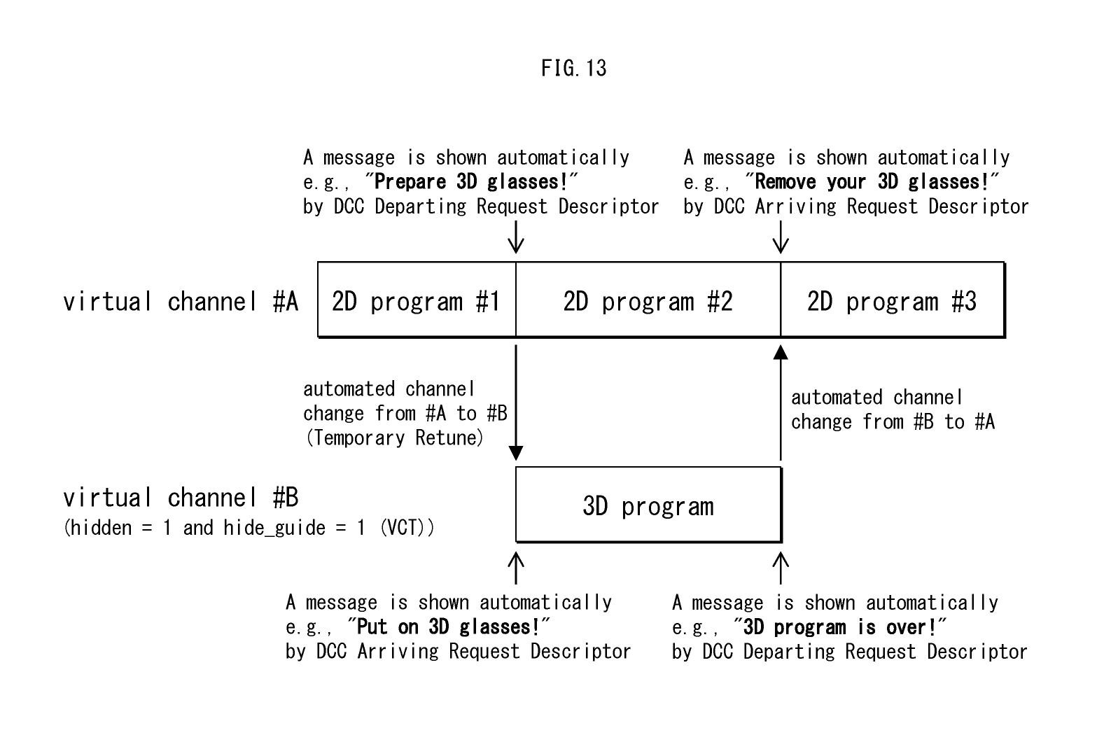

FIG. 13 illustrates examples of messages shown before and after the change of channel from a 2D program channel to a 3D program channel.

A message for displaying to the user may be described within the dcc_test_descriptor( ) field of the DCCT immediately before and after the channel change control. Expanding this framework enables efficient message display when changing between a 2D program channel and a 3D program channel.

FIG. 13 indicates an example of messages shown by the DCC when the 3D glasses necessity term of the dcc_selection_id field and the 3D glasses necessity term of the DCCRR 3D data field both read Y, and the STB 120 performs a channel change from the 2D program channel to the 3D program channel. Before the change from the 2D program channel to the 3D program channel, the dcc_departing_request_descriptor( ) field is used to make a notification such that the 3D glasses should be prepared. Next, immediately after changing to the 3D program channel, the dcc_arriving_request_descriptor( ) field is used to make a notification such that the 3D glasses should be put on. Then, before changing back from the 3D program channel to the 2D program channel, the dcc_departing_request_descriptor( ) field is used to make a notification such that the 3D program is over. Next, immediately after changing back to the 2D program channel, the dcc_arriving_request_descriptor( ) is used to make a notification such that the 3D glasses should be removed.

In the conventional ATSC Standards the dcc_departing/arriving_request_descriptor( ) fields are defined in order to output messages as indicated by the dcc_start_time field for transitioning from the 2D channel to the 3D channel. However, there is no provision for displaying a message as indicated by the dcc_end_time for reverting from the 3D program channel to the 2D program channel.

As such, a new descriptor_tag field is considered for use in defining the new dcc_departing/arriving_request_descriptor( ) fields in order to output the message at the time indicated by the dcc_end_time field. The new descriptor field beneficially references viewing environment and user preference information from the DCCRR 3D and the like, and is able to determine the messages for output according to such information.

This new descriptor field may also be defined or contained within a dcc_additional_descriptor( ) field of the DCC, which is unused in the current ATSC standards.

Alternatively, this form of message display may be used display a message such as “The screen will flicker for a few seconds due to display change” when the STB 120 has determined that changing the display requires a relatively time-consuming process.

### (Variation 1)

(Overview)

The following describes an STB 1620 as a partial variation of the STB 120 pertaining to Embodiment 1 and a broadcasting station 1410 as a partial variation of the broadcasting station 110 pertaining to Embodiment 1, together serving as an Embodiment of the reception device of the disclosure.

The STB 1620 is a reception device receiving, from the broadcasting station 1410, an ultra-high-definition (hereinafter also termed UHD) program (e.g., a program at 4K2K or 8K4K resolution) via a communications network and a standard high-definition program (e.g., a program at 2K1K resolution) associated with the UHD program via broadcast waves, and receiving playback requirement information indicating a UHD program playback requirement from the broadcasting station 1410.

The STB 1620 stores processing capability information indicating the processing capability for UHD programs of the program playback system where the STB 1620 is located.

Upon receiving the playback requirement information associated with the UHD program transmitted by the broadcasting station 1410, the STB 1620 uses a 64-bit dcc_selection_id (described in detail later) in the playback requirement information and DCCRR UHD data (described in detail layer) in the processing capability information stored by the STB to perform a logical operation. The STB 1620 then uses the result of the logical operation to determine whether the playback target is to be a UHD program associated with the playback requirement information or the standard high-definition program corresponding to the UHD program. Then, once the UHD program and the standard high-definition program are transmitted from the broadcasting station 1410, the STB selects the program determined as the playback target and performs a decoding process thereon.

(Configuration)

The following describes the configurations of the STB 1620 and the broadcasting station 1410 with reference to the accompanying drawings, and with a focus on points of difference from the STB 120 and the broadcasting station 110 pertaining to Embodiment 1.

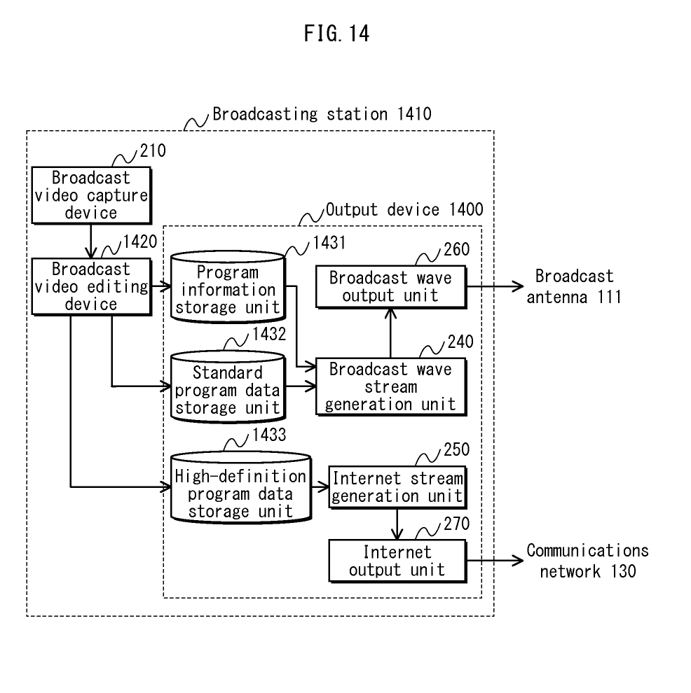

FIG. 14 indicates the overall configuration of the broadcasting station 1410.

As shown, the broadcasting station 1410 differs from the broadcasting station 110 (see FIG. 2) of Embodiment 1 in that the broadcast video editing device 220 is replaced by a broadcast video editing device 1420 the program information storage unit 231 is replaced by a program information storage unit 1431, the 2D program data storage unit 232 is replaced by a standard program data storage unit 1432, and the 3D program data storage unit 233 is replaced by a high-definition program data storage unit 1433.

The broadcast video editing device 1420 partially differs in function from the broadcast video editing device 220 of Embodiment 1, is connected to the broadcast video capture device 210, the program information storage unit 1431, the standard program data storage unit 1432, and the high-definition program data storage unit 1433, edits the audio and video captured by the broadcast video capture device 210, and generates the standard high-definition program data at 2K1K resolution, the UHD program data at 4K2K or 8K4K resolution, and program information associating the standard high-definition program with the UHD program.

The standard high-definition program data generated by the broadcast video editing device 1420 includes a standard high-definition video stream at 2K1K resolution and a standard high-definition program audio stream. The UHD program data similarly includes a UHD video stream at 4K2K or 8K4K resolution and a UHD program audio stream.

The program information storage unit 1431 has the same function as the program information storage unit 231 of Embodiment 1, differing only in storing variant program information and in being connected to the broadcast video editing device 1420 and the broadcast wave stream generation unit 240.

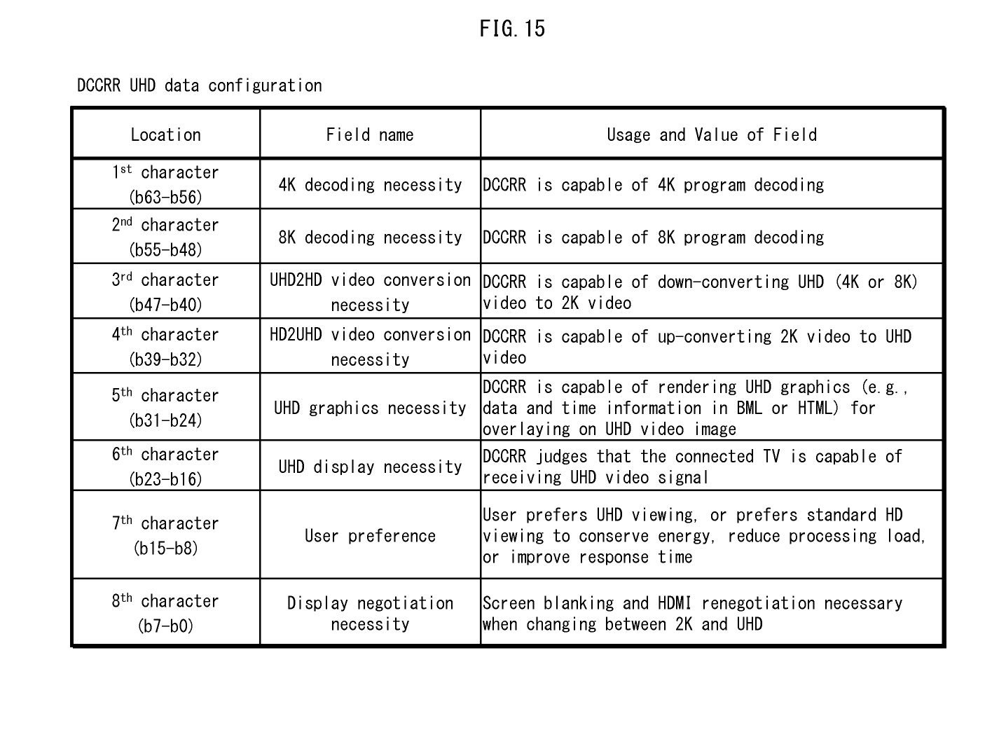

FIG. 15 is a data configuration table showing an example of dcc_selection_id field data configuration, this field being a portion of channel change control information in the variant program information stored by the program information storage unit 1431.

As shown, the dcc_selection_id field is a 64-bit sequence configured from eight 1-byte fields.

The explanation of the broadcasting station 1410 now resumes, with reference to FIG. 14.

The standard program data storage unit 1432 partially differs in function from the 2D program data storage unit 232 of Embodiment 1, is connected to the broadcast video editing device 1420 and the broadcast wave stream generation unit 240, and stores standard program data generated by the broadcast video editing device 1420.

The high-definition program data storage unit 1433 partially differs in function from the 3D program data storage unit 233 of Embodiment 1, is connected to the broadcast video editing device 1420 and the Internet stream generation unit 250, and stores UHD program data generated by the broadcast video editing device 1420.

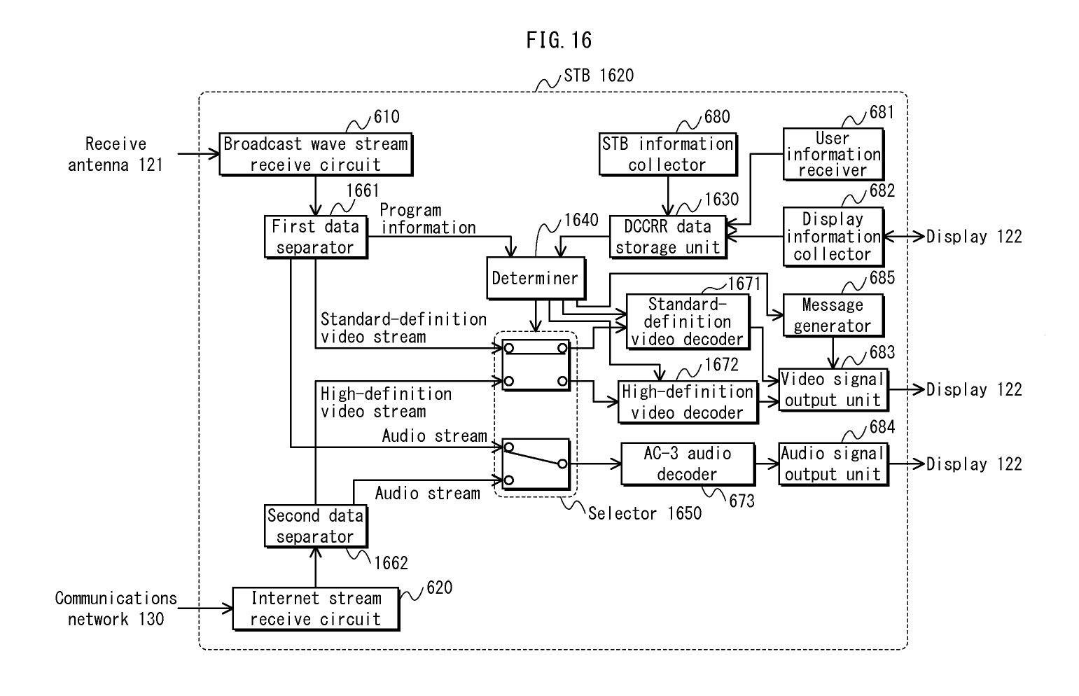

FIG. 16 indicates the overall configuration of the STB 1620.

As shown, the STB 1620 differs from the STB 120 (see FIG. 6) of Embodiment in that the first data separator 661 is replaced by a first data separator 1661, the second data separator 662 is replaced by a second data separator 1662, the determiner 640 is replaced by a determiner 1640, the selector 650 is replaced by a selector 1650, the DCCRR data storage unit 630 is replaced by a DCCRR data storage unit 1630, the MPEG-2 video decoder 671 is replaced by a standard-definition program video decoder 1671, and the MVC video decoder 672 is replaced by a high-definition video decoder 1672.

The first data separator 1661 partially differs in function from the first data separator 661 of Embodiment 1, is connected to the broadcast wave stream receive circuit 610, the determiner 1640, and the selector 1650, and separates the broadcast wave stream output by the broadcast wave stream receive circuit 610 into variant program information, a standard-definition video stream, and an audio stream.

The second data separator 662 partially differs in function from the second data separator 662 of Embodiment 1, is connected to the Internet stream receive circuit 620 and the selector 1650, and separates the Internet stream output by the Internet stream receive circuit 620 into a UHD video stream and an audio stream.

The DCCRR data storage unit 1630 has the same functions as the DCCRR data storage unit 630 of Embodiment 1, differing therefrom in that the data stored therein is DCCRR UHD data, and in being connected to the determiner 1640, the STB information collector 680, the user information receiver 681, and the display information collector 682.

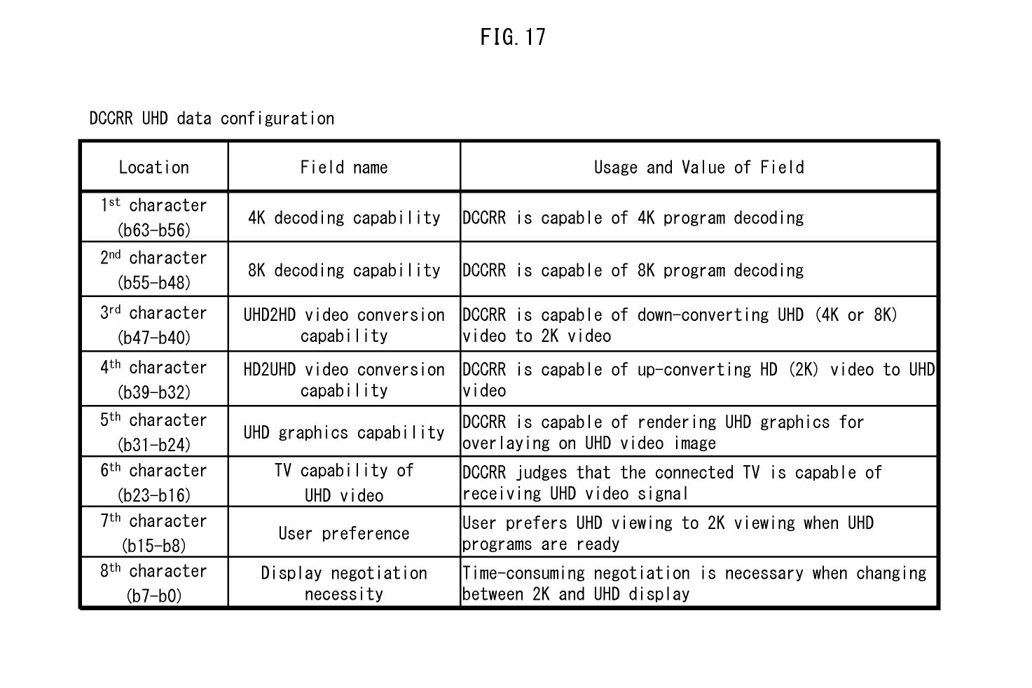

FIG. 17 is a data configuration table showing an example of the DCCRR UHD data stored in the DCCRR data storage unit 1630.

As indicated in FIG. 17, the DCCRR UHD data is a 64-bit sequence configured from eight 1-byte fields, similar to the DCCRR 3D data.

Each of these eight fields corresponds to one of the eight terms making up the dcc_selection_id field, which is a part of the channel change control information in the program information transmitted by the broadcasting station 1410.

Returning to FIG. 16, the explanation of the STB 1620 configuration resumes.

The determiner 1640 partially differs in function from the determiner 640 of Embodiment 1, is connected to the first data separator 1661, the DCCRR data storage unit 1630, the selector 1650, the standard definition video decoder 1671, the high-definition video decoder 1672, and the message generator 685, and has a processor executing a program to execute the following three functions in addition to the message instruction executed by the determiner 640 of Embodiment 1:

Variant Playback Program Determination: When variant program information from the first data separator 1661 has been separated and output, and the variant program information includes a dcc_selection_type field, applying a logical operation associated with the dcc_selection_type field using the dcc_selection_id field in the program information and the DCCRR UD data stored in the DCCRR data storage unit 1630, then determining whether to play back the standard high-definition program or the UHD program according to the results of the logical operation.

Up-convert Instruction Function: When the previous logical operation has been applied and the results indicate that video at 2K1K resolution is to be up-converted into video at 4K2K or 8K4K resolution, outputting a signal to the standard-definition video decoder 1671 to such effect.

Down-convert Instruction Function: When the previous logical operation has been applied and the results indicate that video at 4K2K or 8K4K resolution is to be down-converted into video at 2K1K resolution, outputting a signal to the high-definition video decoder 1672 to such effect.

The standard-definition video decoder 1671 is connected to the selector 1650, the video signal output unit 683, and the determiner 1640, generates video frames by decoding the standard-definition video stream, and generates video frames by up-converting the decoded standard-definition video stream into a resolution of 4K2K or 8K4K.

The high-definition video decoder 1672 is connected to the selector 1650, the video signal output unit 683, and the determiner 1640, generates video frames by decoding the high-resolution video stream, and generates video frames by down-converting the decoded high-resolution video stream into a resolution of 2K1K.

### Embodiment 2

(Overview)

The following describes an STB 2600 as a partial variation of the STB 120 pertaining to Embodiment 1 and a broadcasting station 1810 as a partial variation of the broadcasting station 110 pertaining to Embodiment 1, together serving as an Embodiment of the reception device of the disclosure.

The broadcasting station 1810 transmits 2D program data over broadcast waves and transmits 3D program data having the same content as the 2D program over a communications network 130.

When transmitting the 2D program and the 3D program in parallel, the broadcasting station 1810 generates and transmits a pair of broadcast wave streams in MPEG-2 TS format, in which first program information corresponding to the 2D program and second program information corresponding to the paired 2D program and 3D program (i.e., the MGT, VCT, EIT, and so on) are respectively multiplexed with 2D program data and 3D program data.

The MGT and VCT in the first program information have a packet identifier (hereinafter, PID) of 0x 1FFB as defined by conventional ATSC standards, while in contrast, the MGT and VCT in the second program information have a PID of 0x 1FF6 that differs from the definition in the conventional ATSC standards. The first program information 2D program data are formatted to conform to the conventional ATSC standards. As such, upon receiving the broadcast wave stream in which the first program information and the 2D program data are multiplexed, a reception device conforming to conventional ATSC standards is able to correctly play back the 2D program in the broadcast wave stream.

The STB 2600 receives the broadcast wave stream and/or the Internet stream transmitted by the broadcasting station 1810 and decodes the program therein.

Upon receiving the broadcast wave stream and the Internet stream in parallel, the STB 2600 performs the following: (1) when the second program information in the Internet stream includes an MGT with a PID of 0x 1FF6, selecting one of the 2D program in the 2D program and the 3D program in the Internet stream according to the second program information and decoding the selected program; and (2) when the second program information in the Internet stream does not include an MGT with a PID of 0x 1FF6 and the first information in the broadcast wave stream includes an MGT with a PID of 0x 1FFB, selecting the 2D program in the broadcast wave stream according to the first program information and decoding the program.

The following describes the configurations of the STB 2620 and the broadcasting station 1810 with reference to the accompanying drawings, and with a focus on points of difference from the STB 120 and the broadcasting station 110 pertaining to Embodiment 1.

(Configuration)

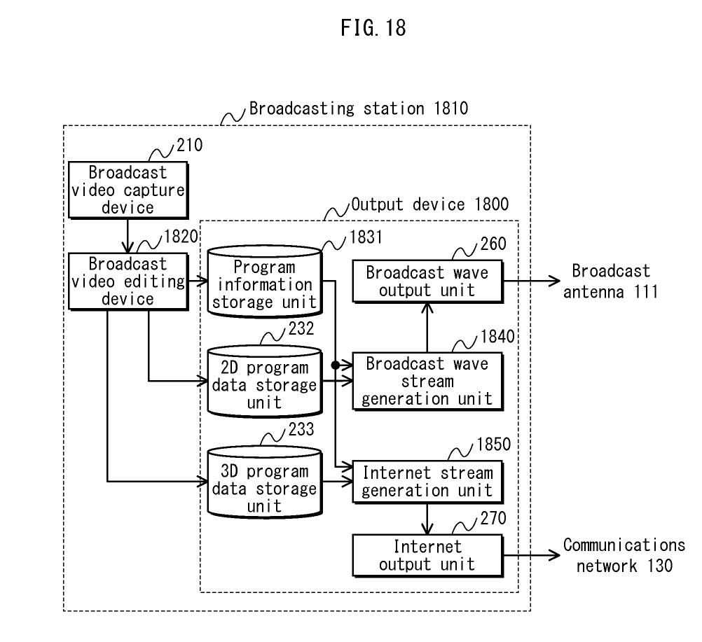

FIG. 18 indicates the overall configuration of the broadcasting station 1810.

As shown, the broadcasting station 1810 differs from the broadcasting station 110 (see FIG. 2) of Embodiment 1 in that the broadcast video editing device 220 is replaced with a broadcast video editing device 1820, the program information storage unit 231 is replaced with a program information storage unit 1831, the broadcast wave stream generation unit 240 is replaced with a broadcast wave stream generation unit 1840, and the Internet stream generation unit 250 is replaced with an Internet stream generation unit 1850.

The broadcast video editing device 1820 partially differs in function from the broadcast video editing device 220 of Embodiment 1, is connected to the broadcast video capture device 210, the program information storage unit 1831, the 2D program data storage unit 232, and the 3D program data storage unit 233, edits the audio and video captured by the broadcast video capture device 210, and generates the 2D program data, the 3D program data, the first program information corresponding to the 2D program, and the second program information associating the 2D program with the 3D program.

The first program information includes an MGT, a Terrestrial VCT (hereinafter, TVCT), an EIT, and an Extended Text Table (hereinafter, ETT), the MGT and the TVCT having a PID of 0x1FFB.

Similarly, the first program information includes an MGT, a Cable VCT (hereinafter, CVCT), an EIT, and an ETT, the MGT and the CVCT having a PID of 0x1FF6.

The MGT, TVCT, CVCT, EIT, and ETT are all formatted to conform to conventional ATSC standards, with the exception that the MGT and CVCT of the second program information have a PID of 0x 1FF6.

The respective data configurations of the MGT, TVCT, CVCT, EIT, ETT, and so on are discussed below, with reference to the drawings.

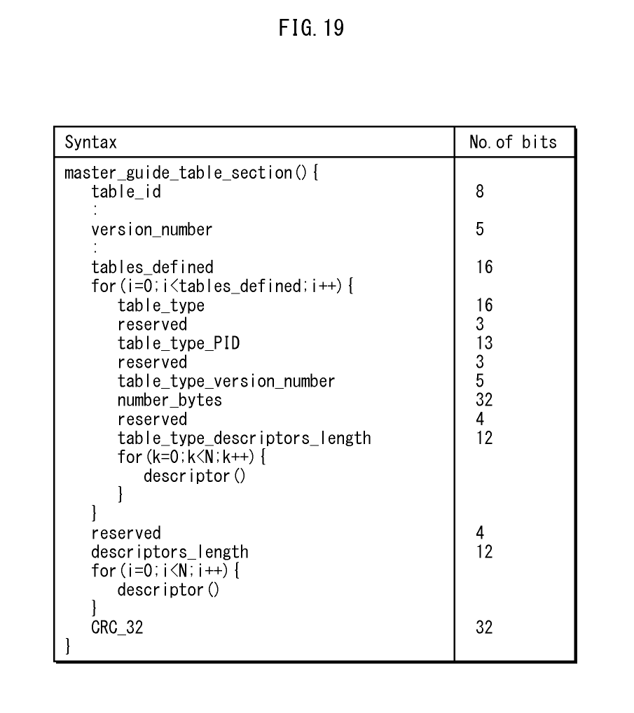

FIG. 19 indicates the MGT data configuration. The MGT is a management table for the entire Program and System Information Protocol (hereinafter, PSIP) describing pointer information for each table therein as a table type in a table_type field and a corresponding PID in a table_type_PID field.

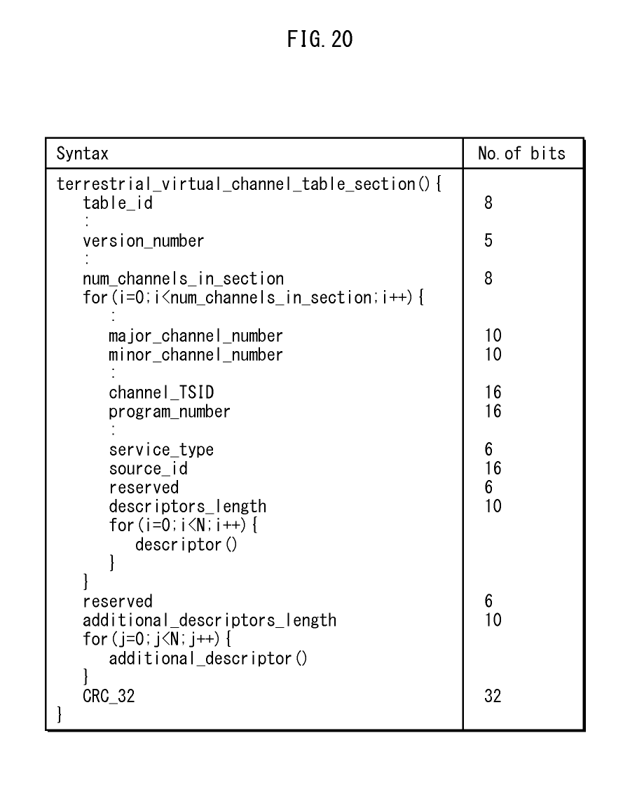

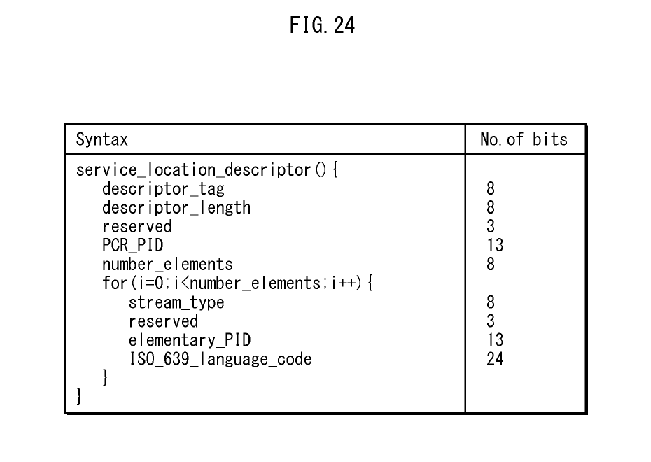

FIG. 20 indicates the TVCT data configuration. The TVCT describes information for virtual channels in MPEG-2 TS. For example, the major/minor_channel_number fields each indicate a user-designated channel number, the channel_TSID field indicates the transport stream id field of the channel, the program number field indicates the relationship to the Program Association Table (hereinafter, PAT) and the Program Map Table (hereinafter, PMT), the service_type field identifies the digital broadcasting service, and the source_id field identifies the elementary stream making up the channel. Further, the descriptor( ) field indicates a service_location_descriptor( ) described in FIG. 24, and indicating elementary stream information making up the channel.

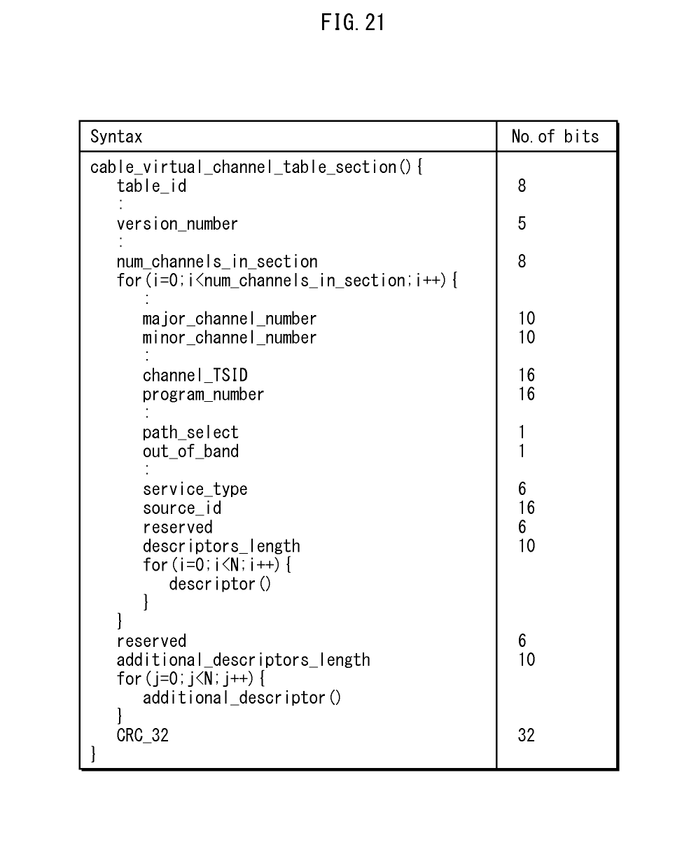

FIG. 21 indicates the CVCT data configuration. The CVCT is configured nearly identically to the TVCT, with the addition of a path_select field identifying a path and an out_of_band field indicating whether or not the channel is a physically distinct transport channel.

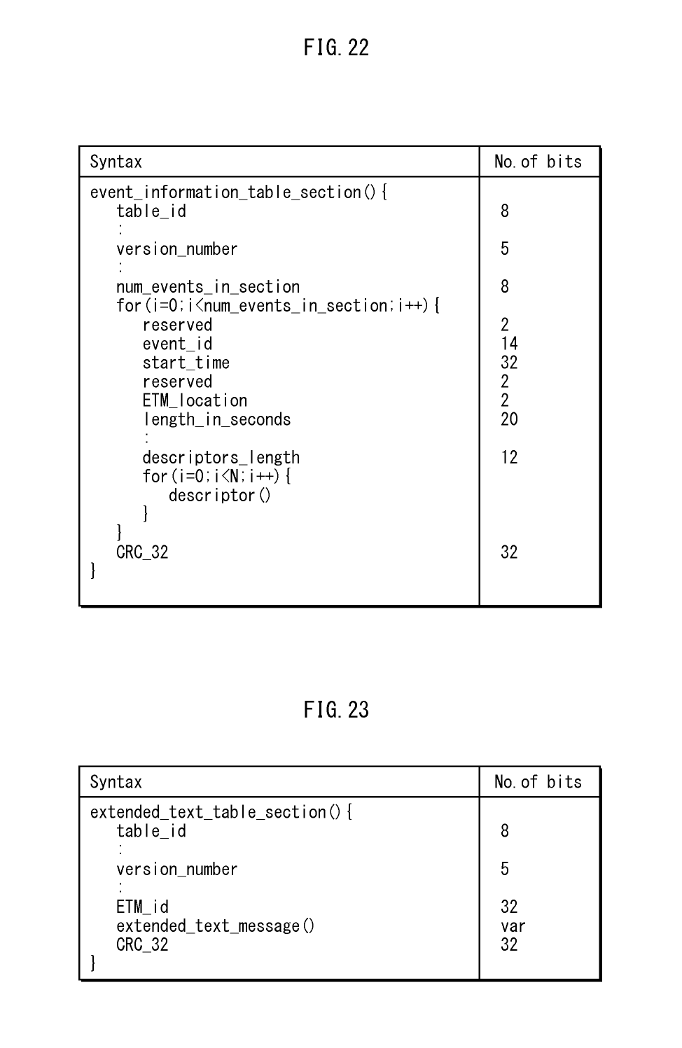

FIG. 22 indicates the EIT data configuration. The EIT indicates a summary of each program (also termed event) and is presented to the user as the EPG or the like. For each program, the event_id field indicates the program ID, the start_time field indicates the program start time, the ETM_location field indicates a physical transport channel for additional text information (i.e., an Extended Text Message, hereinafter ETM), and the length_in_seconds field indicates the program playback length.

FIG. 23 indicates the ETT data configuration. The ETT stores extended text information for the virtual channel and the program. The ETM_id field combines the source_id field and the event_id field, such that extended text information is identified using the source_id only when intended for the channel and using the source_id in combination with the event_id when intended for the program. The extended text information is described within the extended_text_message( ) field.

FIG. 24 is a data configuration diagram for the service_location_descriptor( ) field. The service_location_descriptor( ) field is used within the TVCT and CVCT and has, for each elementary stream making up the channel, a stream_type field identifying the elementary stream encoding type, an elementary_PID field giving the elementary stream PID, and an ISO_{—}639_language_code field indicating the language of the elementary scheme.

The respective relationships between the MGT, the VCT (i.e., TVCT or CVCT) and the EIT in the first and second program information are described next, with reference to the drawings.

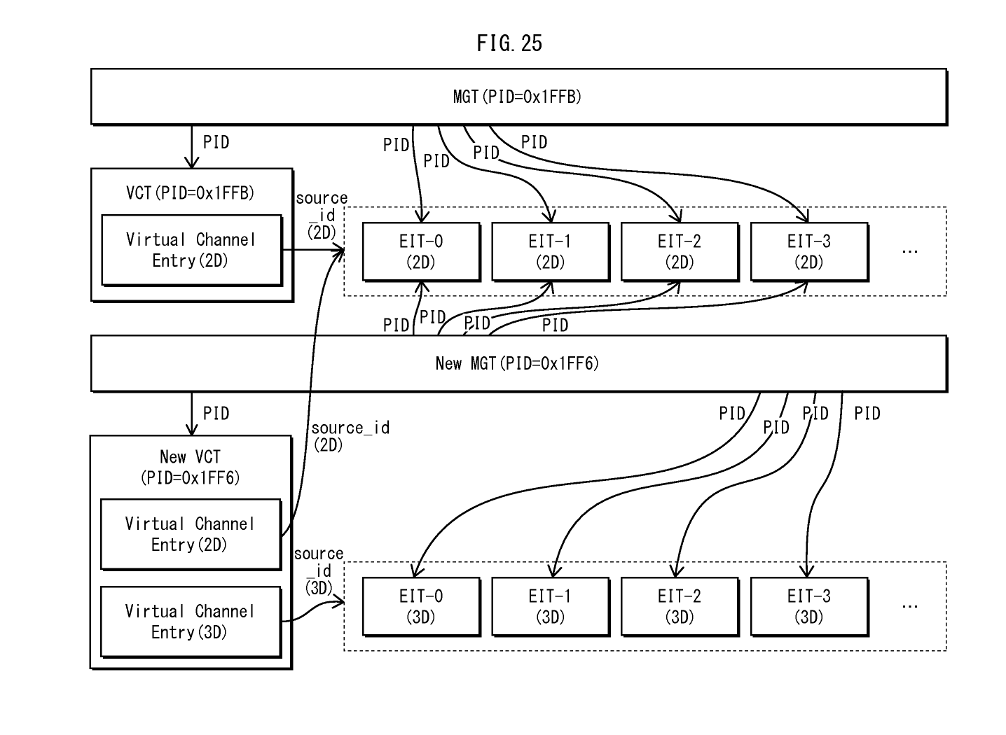

FIG. 25 schematically represents the respective relationships between the MGT, the VCT, and the EIT in the first and second program information.

Here, the MGT of the first program information is simply termed an MGT while the MGT of the second program information is referred to as a new MGT. Likewise, the VCT of the first program information is simply termed a VCT while the VCT of the second program information is referred to as a new VCT

As shown in FIG. 25, the PID of the MGT and VCT is fixed as being 0x 1FFB, while the PID of the new MGT and the new VCT are fixed as being 0x1FF6.

Channel information for the 2D program (labelled Virtual Channel Entry (2D)) indicating the broadcast service in conformity with the conventional ATSC standards is registered in the VCT. Similarly, the same channel information for the 2D program and new 3D information (labelled Virtual Channel Entry (3D)) for the 3D program indicating a new broadcast service is registered in the new VCT.

In FIG. 25, the boxes labelled EIT-0 (2D), EIT-1 (2D), EIT-2 (2D), EIT-3 (2D) and so on each represent an EIT indicating program information for a three-hour block of the 2D program channel and are associated with the source_id field (labelled source_id (2D)) thereof. Each PID is registered in the MGT as well as the new MGT.

Similarly, the boxes labelled EIT-0 (3D), EIT-1 (3D), EIT-2 (3D), EIT-3 (3D) and so on each represent an EIT indicating program information for a three-hour block of the 3D program channel and are associated with the source_id field (labelled source_id (3D)) thereof. Each PID is registered in the new MGT.

The 3D program channel information in the new VCT may be used when the service_type field is set to 0x02 (i.e., for digital broadcasting) or to 0x07 (i.e., for extended service broadcasting). Alternatively, the stream_type field within the service_location_descriptor( ) field may be used with any new value to denote the 3D program.

As shown in FIG. 25, the MGT and the VCT are described only in a range used by the 2D program channel, such that new data pertaining to a 3D program is not input to a reception device incompatible with 3D programs. A reception device compatible only with conventional ATSC standards processes the MGT and the VCT having the PID of 0x 1FFB, while the separator disposes of the new MGT and new VCT, which have a different PID such as 0x1FF6. Accordingly, the program playback process proceeds in conformity with the conventional ATSC standards.

In contrast, the information indicating all channels, including the 3D program channel, is defined by the new MGT and the new VCT, having a PID such as 0x1FF6.

The new MGT references the new VCT. The new VCT includes not only the 2D program channel information but also the 3D program channel information.

The same 2D program channel information is defined in the new MGT and the new VCT and the MGT and VCT. Having the new MGT and the new VCT duplicate the information for the 2D program channel defined in the MGT and VCT enables the reception device compatible with the 3D program to process only the new MGT and the new VCT. Thus, the reception device compatible with the 3D program is not required to process the new MGT, the new VCT, the MGT, and the VCT, providing an advantageous simplification of processing.

Specifically, a new 3D program-compatible device can be developed with relative ease by implementing a PSIP controller with the newly-added 3D program processing and acquiring the new MGT and the new VCT instead of the conventional MGT and VCT, i.e., by simply changing the PID setting of the separator.

Also, given that the new VCT includes the 2D program channel information and that the new MGT describes the respective reference PIDs of the EITs for the 2D program channel, the new 3D program-compatible reception device has no need to convert any 2D program-related implementation.

Also, the 3D program-compatible reception device need only use the 3D program channel information, referencing the EITs for the 2D program from the new MGT and the new VCT only.

Separately registering the PSIP data configurations for the conventional broadcast service (i.e., for 2D) and the new broadcast service (i.e., for 3D) in this manner enables the reception device to select the appropriate processing rather than having special broadcast service control for each device. Also, the amount of transmitted data is reduced by sharing the information pertaining to the conventional broadcast service (i.e., the EIT, the ETT, and so on) without duplication. In other words, the data load is made more efficient by sharing the larger EIT and ETT while duplicating the smaller MGT and VCT for individual transmission according to reception device capabilities.

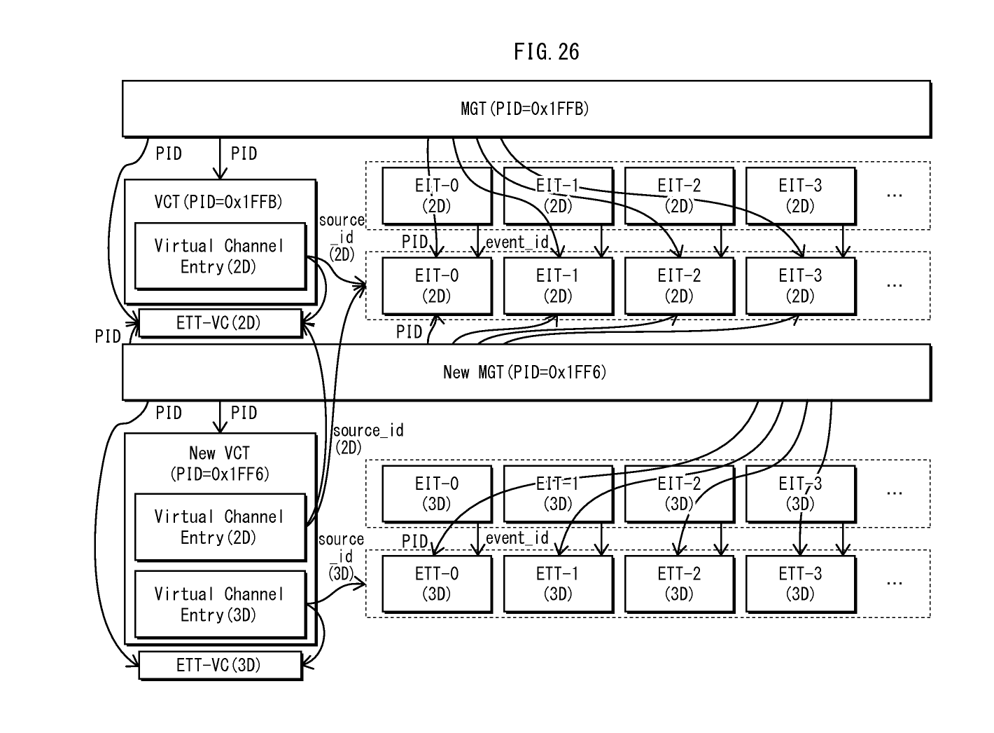

FIG. 26 corresponds to the PSIP configuration shown in FIG. 25, but also includes the ETT. The arrows pointing to the EITs in FIG. 25 are omitted so as to more easily illustrate the reference relationships of the ETT.

The ETT-VC (2D) is registered as additional text information corresponding to the 2D program channel information, the ETTs 0, 1, 2, and 3 (2D) are registered as additional text information corresponding to the 2D program, the ETT-VC (3D) is registered as additional text information corresponding to the 3D program channel information, and the ETTs 0, 1, 2, and 3 (3D) are registered as additional text information for the 3D program.

Accordingly, the ETT is also transmitted separately for the conventional broadcasting service and for the new broadcasting service, much like the EIT. This enhances the aforementioned effect.

The explanation of the broadcasting station 1810 now resumes, with reference to FIG. 18.

The program information storage unit 1831 has the same function as the program information storage unit 231 of Embodiment 1, differing only in storing first and second program information and in being connected to the broadcast video editing device 1820, the broadcast wave stream generation unit 1840, and the Internet stream generation unit 1850.

The broadcast wave stream generation unit 1840 partially differs in function from the broadcast wave stream generation unit 240 of Embodiment 1, is connected to the program information storage unit 1831, the 2D program data storage unit 232, and the broadcast wave output unit 260, and generates a broadcast wave stream in MPEG-2 TS format by multiplexing the 2D program data stored in the 2D program data storage unit 232 with the first program information stored in the program information storage unit 1831.

The Internet stream generation unit 1850 partially differs in function from the Internet stream generation unit 250 of Embodiment 1, is connected to the program information storage unit 1831, the 3D program data storage unit 233, and the Internet output unit 270, and generates an Internet stream in MPEG-2 TS format by multiplexing the 3D program data stored in the 3D program data storage unit 233 with the second program information stored in the program information storage unit 1831.

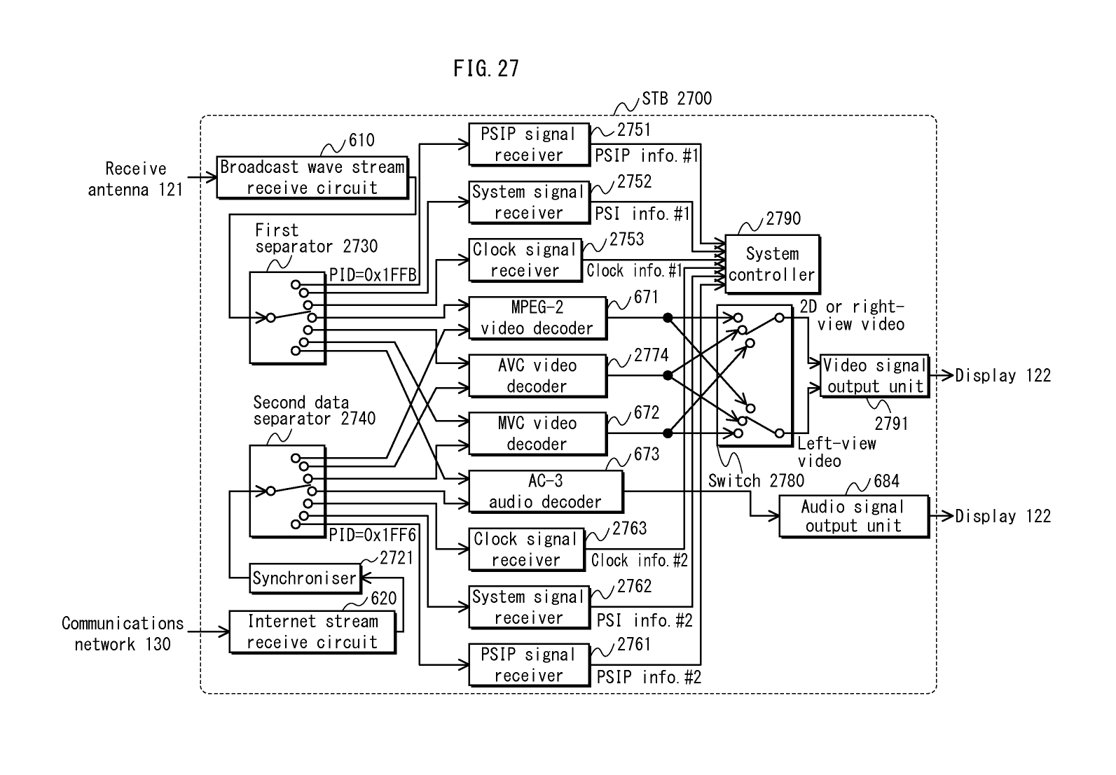

FIG. 27 indicates the overall configuration of the STB 2700.

As shown, the STB 2700 is similar to the STB 120 (see FIG. 6) of Embodiment 1, differing therefrom in that the first data separator 661, the second data separator 662, the determiner 640, the selector 650, the DCCRR data storage unit 630, the STB information collector 680, the user information receiver 681, the display information collector 682, the message generator 685, and the video signal output unit 683 have been removed, and in that a first separator 2730, a second separator 2740, a synchroniser 2721, PSIP signal receivers 2751 and 2761, system signal receivers 2752 and 2762, clock signal receivers 2753 and 2763, an AVC video decoder 2774, a system controller 2790, a switcher 2780, and a video signal output unit 2791 have been added.

The first separator 2730 is connected to the broadcast wave stream receive circuit 610, the PSIP signal receiver 2751, the system signal receiver 2752, the clock signal receiver 2753, the MPEG-2 video decoder 671, the AVC video decoder 2774, the MVC video decoder 672, and the AC-3 audio decoder 673, separates the packets making up the broadcast wave stream output by the broadcast wave stream receive circuit 610, and outputs each packet in accordance with the PID to one of the PSIP signal receiver 2751, the system signal receiver 2752, the clock signal receiver 2753, the MPEG-2 video decoder 671, the AVC video decoder 2774, the MVC video decoder 672, and the AC-3 audio decoder 673.

The first separator 2730 outputs each packet having a PID that corresponds to one of the above-listed destinations, and does not output any packet having a PID that does not correspond to one of the above-listed destinations.

The correspondence between the packet PIDs and the destinations is established by the later-described system controller 2790, with the exception of PID value of 0x1FFB. The PID value of 0x1FFB is fixed as corresponding to the PSIP signal receiver 2751.

The PSIP signal receiver 2751 is connected to the first separator 2730 and the system controller 2790, receives the packets having a PID value of 0x1FFB output from the first separator 2730, acquires the PSIP information (labelled PSIP info. #1) from the MGT and VCT in the received packets, and outputs the information to the system controller 2790.

The PSIP signal receiver 2751 conforms to the conventional ATSC standards.

The system signal receiver 2752 is connected to the first separator 2730 and the system controller 2790, receives packets output from the first separator 2730, generates system control information (labelled PSI info. #1) from the system control information (i.e., from the PSI) transported by the PAT and PMT in the received packets, and outputs the information to the system controller 2790.

The system signal receiver 2752 conforms to conventional ATSC standards.

The clock signal receiver 2753 is connected to the first separator 2730 and the system controller 2790, receives the PCR packets for generating a system time clock (hereinafter, STC) from the first separator 2730, generates STC information (labelled Clock info. #1), and outputs the information to the system controller 2790.

The clock signal receiver 2753 conforms to the conventional ATSC standards.

The synchroniser 2721 is connected to the Internet stream receive circuit 620 and the second separator 2740, buffers the Internet stream output from the Internet stream receive circuit, and adjusts the timing at which the Internet stream is input to the second separator 2740.

For example, when the time given by the later-described second clock information (labelled Clock info. #2) is ahead of the time given in Clock info. #1, the synchroniser 2721 delays the former so as to match the timing at which the Internet stream is input to the second separator 2740.

The second separator 2740 is connected to the synchroniser 2721, the PSIP signal receiver 2761, the system signal receiver 2762, the clock signal receiver 2763, the MPEG-2 video decoder 671, the AVC video decoder 2774, the MVC video decoder 672, and the AC-3 audio decoder 673, separates the packets making up the Internet stream output by the synchroniser 2721, and outputs each packet in accordance with the PID to one of the PSIP signal receiver 2761, the system signal receiver 2762, the clock signal receiver 2763, the MPEG-2 video decoder 671, the AVC video decoder 2774, the MVC video decoder 672, and the AC-3 audio decoder 673.

The second separator 2740 outputs each packet having a PID that corresponds to one of the above-listed destinations, and does not output any packet having a PID that does not correspond to one of the above-listed destinations.

The correspondence between the packet PIDs and the destinations is established by the later-described system controller 2790, with the exception of PID value of 0x 1FF6. The PID value of 0x 1FF6 is fixed as corresponding to the PSIP signal receiver 2761.

The PSIP signal receiver 2761 is connected to the second separator 2740 and the system controller 2790, receives the packets having a PID value of 0x1FF6 output from the second separator 2740, acquires the PSIP information (labelled PSIP info. #2) from the new MGT and the new VCT in the received packets, and outputs the information to the system controller 2790.

The system signal receiver 2762 is connected to the second separator 2740 and the system controller 2790, receives packets output from the second separator 2740, generates system control information (labelled PSI info. #2) from the system control information (i.e., the PSI) transported by the PAT and PMT in the received packets, and outputs the information to the system controller 2790.

The clock signal receiver 2763 is connected to the second separator 2740 and the system controller 2790, receives the PCR packets for generating an STC from the second separator 2740, generates STC information (labelled Clock info. #2), and outputs the information to the system controller 2790.

The AVC video decoder 2774 is connected to the first separator 2730, the second separator 2740, and the switcher 2780, and decodes the video stream encoded in MPEG-4 AVC format into a video frame group.

The switcher 2780 is connected to the MPEG-2 video decoder 671, the AVC video decoder 2774, the MVC video decoder 672, and the video signal output unit 2791, is controlled by the system controller 2790, selects one of (1) a 3D video frame group made up of a right-view video and a left-view video and (2) a 2D video frame group output by one of the MPEG-2 video decoder 671, the AVC video decoder 2774, and the MVC video decoder, and outputs the selected group to the video signal output unit 2791.

The video signal output unit 2791 is connected to the switcher 2780 and to the display 122 via the HDMI cable 123, and outputs the video frame group output by the switcher 2780 to the display 122.

The system controller 2790 is connected to the PSIP signal receivers 2751 and 2761, the system signal receivers 2752 and 2762, and the clock signal receivers 2753 and 2763, and has the following six functions:

First Separator Control: when PSIP info. #1 is input from PSIP signal receiver 2751 and PSIP info. #2 is not input from PSIP signal receiver 2761, associating the PIDs and destinations for the first separator 2730 in accordance with PSIP info. #1 such that the 2D program in the broadcast wave stream is played back correctly.

The PIDs and destinations are associated as follows: packets including a PSI have a PID associated with the system signal receiver 2752, packets including a PCR have a PID associated with the clock signal receiver 2753, packets including video data encoded in MPEG-2 format have a PID associated with the MPEG-2 video decoder 671, packets including video data encoded in MPEG-4 AVC format have a PID associated with the AVC video decoder 2774, packets including video data encoded in MPEG-4 MVC format have a PID associated with the MVC video decoder 672, and packets including audio data have a PID associated with the AC-3 audio decoder 673.

The absence of PSIP info. #2 in the input from the PSIP signal receiver 2761 is detected by determining a transmission frequency or a maximum transmission interval for the new MGT and the new VCT.

For example, upon determining that the new MGT and the new VCT have a transmission frequency equal to or higher than that of the MGT and VCT, repeatedly inputting PSIP info. #1 serves as a notification that PSIP info. #2 will not be input.

Alternatively, when the new MGT and the new VCT are not received over a longer reception interval than the maximum transmission interval, the determination is made that no PSIP info. #2 will be input.

In the ATSC standards, the maximum transmission intervals for the MGT and the VCT are 150 ms and 400 ms, respectively. As such, the maximum transmission intervals for the new MGT and the new VCT may be likewise set to 150 ms and 400 ms, respectively, or to shorter times in order to reduce the processing delay time.

The presence of the new MGT and the new VCT may also be determined using a reserved area of the MGT. For example, one bit of the (3-bit) reserved field immediately following the table_type field may be used to indicate whether or not the new MGT and the new VCT are present.

Second Separator Control: when PSIP info. #2 is input from PSIP signal receiver 2761, associating the PIDs and destinations for the first separator 2730 and the second separator 2740 in accordance with PSIP info. #2 such that the 2D program in the broadcast wave stream or the 3D program in the Internet stream is played back correctly.

The PIDs and destinations are associated as follows: (1) for the 2D program, packets including a PSI have a PID associated with the system signal receiver 2752, packets including a PCR have a PID associated with the clock signal receiver 2753, packets including video data encoded in MPEG-2 format have a PID associated with the MPEG-2 video decoder 671, packets including video data encoded in MPEG-4 AVC format have a PID associated with the AVC video decoder 2774, packets including video data encoded in MPEG-4 MVC format have a PID associated with the MVC video decoder 672, and packets including audio data have a PID associated with the AC-3 audio decoder 673; (2) for the 3D program, packets including a PSI have a PID associated with the system signal receiver 2762, packets including a PCR have a PID associated with the clock signal receiver 2763, packets including video data encoded in MPEG-2 format have a PID associated with the MPEG-2 video decoder 671, packets including video data encoded in MPEG-4 AVC format have a PID associated with the AVC video decoder 2774, packets including video data encoded in MPEG-4 MVC format have a PID associated with the MVC video decoder 672, and packets including audio data have a PID associated with the AC-3 audio decoder 673.

First System Control: when PSIP info. #1 is input from PSIP signal receiver 2751 and PSIP info. #2 is not input from PSIP signal receiver 2761, controlling the STB 2700 in accordance with the PSI info. #1 output from the system signal receiver 2752.

Second System Control: when PSIP info. #2 is input from PSIP signal receiver 2761, controlling the STB 2700 in accordance with the PSI info. #2 output from the system signal receiver 2762.

First Clock Control: when PSIP info. #1 is input from PSIP signal receiver 2751 and PSIP info. #2 is not input from PSIP signal receiver 2761, generating the STC in accordance with the Clock info. #1 output from the clock signal receiver 2753.

Second Clock Control: when PSIP info. #2 is input from PSIP signal receiver 2761, generating the STC in accordance with the Clock info. #2 output from the clock signal receiver 2753.

The operations of the STB 2700, configured as described above, are described below with reference to the accompanying drawings.

(Operations)

The information labelled PSIP info. #2 generated by the PSIP signal receiver 2761 is included in the PSIP information. When the 3D program channel information is in the new VCT, the STB 2700 transfers the video stream having the appropriate PID from the second separator 2740 to the appropriate video decoder in order to play back the 3D program.

For instance, when instructed to transfer a video stream for one eye in MPEG-4 AVC format, which is not an MPEG-2 video stream (e.g., determinable from the stream_type field within the service_location_descriptor( ) field), the MPEG-4 AVC video stream is input to the AVC video decoder 2774.

The MPEG-2 video frames and the MPEG-4 AVC video frames are each selected for output according to designation information such that one serves as the right-view video and the other serves as the left-view video, and respectively output as right- or left-view video selected by the switcher 2780.

The designation information for the left- and right-view may be written using a reserved area in the VCT or a new descriptor( ) field in the PSI/SI. Specifically, when MPEG-2 video frames and MPEG-4 AVC video frames are used, the 3D program creator may intentionally specify which of the left-view or the right-view frames should be shown to a user of a conventional reception device for 2D viewing. In such a situation, provided that the switcher 2780, which is able to switch between the left and right views, is within the STB 2700, then the designation information enables the conventional reception device to play back only the designated left- or right-view video.

Further, when transmitting a 3D video stream as an MPEG-4 MVC video stream that is independent from an MPEG-2 video stream, the stream_type field within the service_location_descriptor( ) field may be used to identify the MPEG-4 MVC stream for independent 3D program broadcasting, or else a new descriptor( ) field in the PSI/SI may be used for this purpose.

The base view and the non-base view in the MPEG-4 MVC video stream each have information indicating whether that view is the left-view or the right-view. As previously described, a reserved area of the VCT or a new descriptor( ) field in the PSI/SI may also be used for this purpose.

Although a conventional reception device only having an MPEG-2 video decoder is unable to decode the base view in the MPEG-4 MVC video stream, the STB 2700 may perform 2D program playback not by using the MPEG-2 video stream but rather by decoding the base view of the MPEG-4 MVC video stream for 2D viewing. Permission information for this approach may be written using a reserved area in the VCT or a new descriptor( ) field in the PSI/SI.

The information labelled PSIP info. #2 generated by the PSIP signal receiver 2761 may be read safely as additional information appended to the control information for the switcher 2780, which is not found in conventional PSIP.

Also, when 2D and 3D intervals are arranged sequentially, the switcher 2780 may perform control such that during the 2D intervals, the same 2D video is output for both eyes. This may also be realised by using a reserved area of the VCT or a new descriptor( ) field in the PSI/SI to set the 2D and 3D intervals with a PTS base, and describing control information (i.e., an operating mode) for the switcher 2780 that enables realisation.

Continuing to decode 3D output during a switch between 2D and 3D scenes is beneficial in negating the need for HDMI renegotiation and the like, which is required when switching between 2D and 3D video signals and when switching the drive mode of the interface or the display panel. The accompanying interruption and blurring of playback video is thus negated.

The above-described situations for different video information are not intended as limitations, and may be modified for a new broadcast service using audio, subtitles, graphics superposed on the video, and so on. For example, a new broadcasting service may transmit neat closed captions for display by the STB 2700, or may have supplementary information in HTML5 base graphics supporting the correct interpretation be synchronised with the video and superposed thereon.

Having the PSIP be divided between the conventional service and the new service enables high-efficiency transmission such that various future services to be implemented without compatibility issues.

(Inquiry 1)

The following describes an inquiry regarding a reception device confirming to conventional ATSC standards, and thus not conforming to the 3D playback format of a 3D program, in a case where the reception device receives a broadcast wave stream transmitted by the broadcasting station 1810.

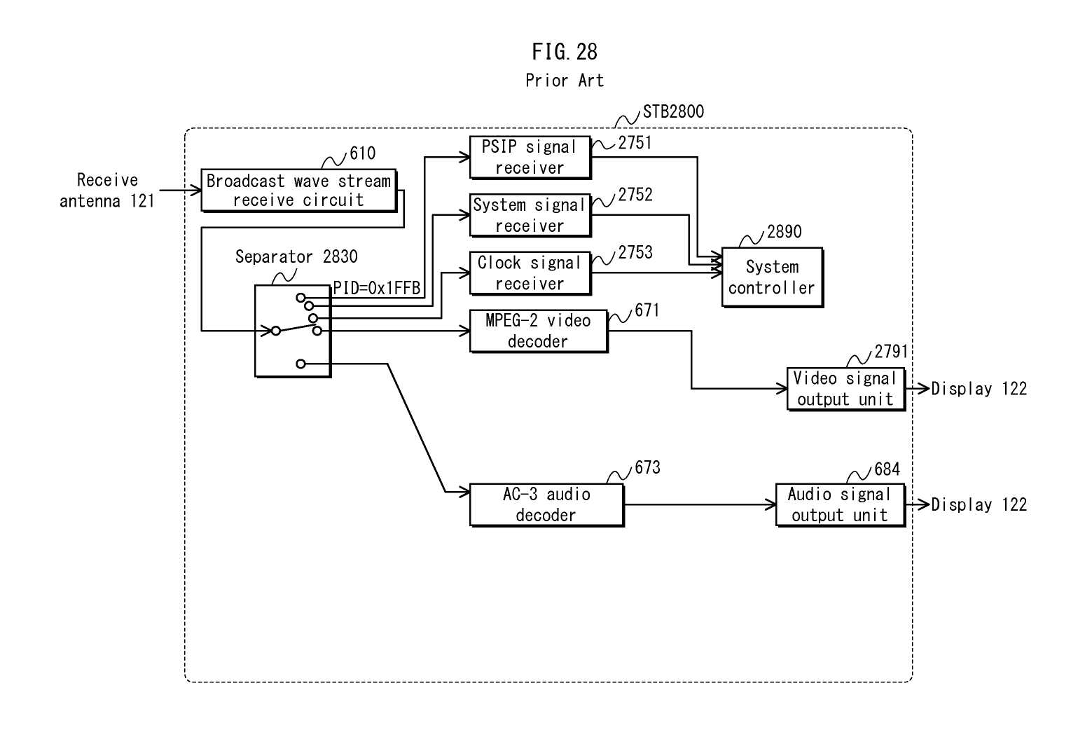

FIG. 28 is a schematic diagram of an STB 2800 for the reception device confirming to the conventional ATSC standards, and not conforming to the 3D playback format.

As shown, the STB 2800 is similar to the STB 2700, differing in that the Internet stream receive circuit 620, the synchroniser 2721, the second separator 2740, the PSIP signal receiver 2761, the system signal receiver 2762, the clock signal receiver 2763, the AVC video decoder 2774, the MVC video decoder 672, and the switcher 2780 have been removed, in that the first separator 2730 is replaced by a separator 2830, and in that the system controller 2790 is replaced by a system controller 2890.

The separator 2830 partially differs in function from the first separator 2730 of Embodiment 2, separates the packets making up the broadcast wave stream output by the broadcast wave stream receive circuit 610, and outputs each packet in accordance with the PID to one of the PSIP signal receiver 2751, the system signal receiver 2752, the clock signal receiver 2753, the MPEG-2 video decoder 671, and the AC-3 audio decoder 673.

The separator 2830 outputs each packet having a PID that corresponds to one of the above-listed destinations, and does not output any packet having a PID that does not correspond to one of the above-listed destinations.

The correspondence between the packet PIDs and the destinations is established by the system controller 2890, with the exception of PID value of 0x1FFB. The PID value of 0x1FFB is fixed as corresponding to the PSIP signal receiver 2851.

The system controller 2890 partially differs in function from the system controller of Embodiment 2, and realises the following three functions:

Separator Control: when PSIP info. #1 is input from PSIP signal receiver 2751, associating the PIDs and destinations for the separator 2830 in accordance with PSIP info. #1 such that the 2D program in the broadcast wave stream is played back correctly.

The PIDs and destinations are associated as follows: packets including a PSI have a PID associated with the system signal receiver 2752, packets including a PCR have a PID associated with the clock signal receiver 2753, packets including video data encoded in MPEG-2 format have a PID associated with the MPEG-2 video decoder 671, and packets including audio data have a PID associated with the AC-3 audio decoder 673.

System Control: when PSIP info. #1 is input from PSIP signal receiver 2751, controlling the STB 2800 in accordance with the PSI info. #1 output from the system signal receiver 1.

Clock Control: when PSIP info. #1 is input from PSIP signal receiver 2751, generating the STC in accordance with the Clock info. #1 output from the clock signal receiver 2753.

The STB 2800, configured as described above, receives the broadcast wave from the broadcasting station 1810 and has the broadcast wave stream receive circuit 610 demodulate the received broadcast wave and generate a broadcast wave stream. The broadcast wave stream conforms to the conventional ATSC standards. Accordingly, the STB 2800 is able to correctly play back a 2D program in the broadcast wave stream.

That is, the separator 2830 separates the packets in the broadcast wave stream having a PID of 0x1FFB for output to the PSIP signal receiver 2751, and the PSIP signal receiver 2751 acquires the information labelled PSIP info. #1 from the MGT and VCT conforming to the conventional ATSC standards. The separator 2830 then outputs the packets from the broadcast wave stream such that packets including a PCI are separated and output to the system signal receiver 2752, packets including a PCR are separated and output to the clock signal receiver 2753, packets including video data encoded in MPEG-2 format are separated and output to the MPEG-2 video decoder 671, and packets including audio data are separated and output to the AC-3 audio decoder 673.

Accordingly, the STB 2800 is able to correctly play back the 2D program in the broadcast wave stream transmitted by the broadcasting station 1810.

Also, for example, when the broadcast wave stream transmitted by the broadcasting station 1810 includes another MGT or VCT in packets with a PID other than 0x1FFB (e.g., 0x 1FF6), the separator 2830 does not output the other MGT or VCT to the PSIP signal receiver 2751. As such, the PSIP signal receiver 2751 does not generate information from the other MGT or VCT.

(Inquiry 2)

The following describes an inquiry into a situation where the broadcasting station 1810 transmits a broadcast wave stream that includes first program information (hereinafter, first theoretical program information) that in turn includes an MGT and VCT having a PID of 0x1FFB and containing both 2D program information and 3D program information, when the above-described STB 2800 receives such a broadcast wave stream.

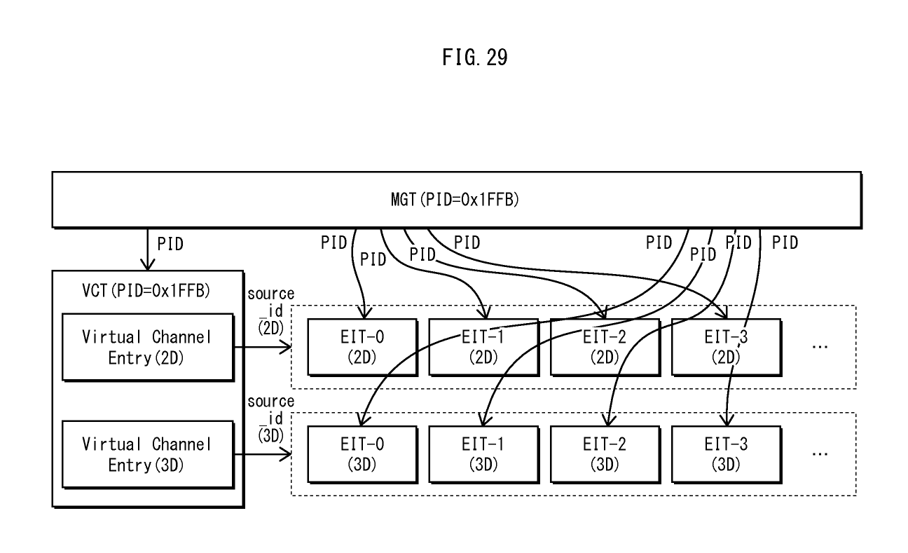

FIG. 29 schematically represents the respective relationships between the MGT, the VCT, and the EIT in the first theoretical program information.

As shown, the PID of the MGT and VCT is fixed as being 0x 1FFB.

Similarly, the same channel information for the 2D program and new 3D program information indicating a new broadcast service is registered in the VCT.

In FIG. 29, the boxes labelled EIT-0 (2D), EIT-1 (2D), EIT-2 (2D), EIT-3 (2D) and so on are associated with the source_id field (labelled source_id (2D)) of the 2D program. Each PID is registered in the MGT.

Also, the boxes labelled EIT-0 (3D), EIT-1 (3D), EIT-2 (3D), EIT-3 (3D) and so on are associated with the source_id field (labelled source_id (3D)) of the 3D program. Each PID is registered in the MGT.

The STB 2800 receives the broadcast wave from the broadcasting station 1810 and has the broadcast wave stream receive circuit 610 demodulate the received broadcast wave and generate a broadcast wave stream.

The separator 2830 then separates the packets having a PID of 0x 1FFB from the broadcast wave stream for output to the PSIP signal receiver 2751.

However, the 3D program channel information indicated for the new broadcast service in the VCT does not conform to the conventional ATSC standards. Thus, the PSIP signal receiver 2751 that does conform to the conventional ATSC standards may not be able to correctly extract the PSIP information (labelled PSIP info. #1) from the MGT and VCT in the received packets.

Therefore, the STB 2800 may experience a malfunction.

### (Variation 2)

(Overview)

The following describes an STB 3100 as a partial variation of the STB 2700 pertaining to Embodiment 2 and a broadcasting station 3010 as a partial variation of the broadcasting station 1810 pertaining to Embodiment 2, together serving as an Embodiment of the reception device of the disclosure.

The broadcasting station 1810 pertaining to Embodiment 2 uses broadcast waves to transmit a broadcast wave stream that includes 2D program data and first program information, and uses the communications network 130 to transmit an Internet stream that includes 3D program data and second program information.

In contrast, the broadcasting station 3010 pertaining to Variation 2 uses broadcast waves to transmit a single stream that includes the 2D program data, the first program information, the 3D program data, and the second program information.

Also, the STB 2700 receives, from the broadcasting station 1810, the broadcast wave stream transmitted using the broadcast waves and the Internet stream transmitted using the communications network 130.

In contrast, the STB 3100 pertaining to Embodiment 2 receives the broadcast wave stream transmitted over the broadcast waves by the broadcasting station 3010.

The following describes the configurations of the STB 3100 and the broadcasting station 3010 with reference to the accompanying drawings, and with a focus on points of difference from the STB 2600 and the broadcasting station 1810 pertaining to Embodiment 1.

(Configuration)

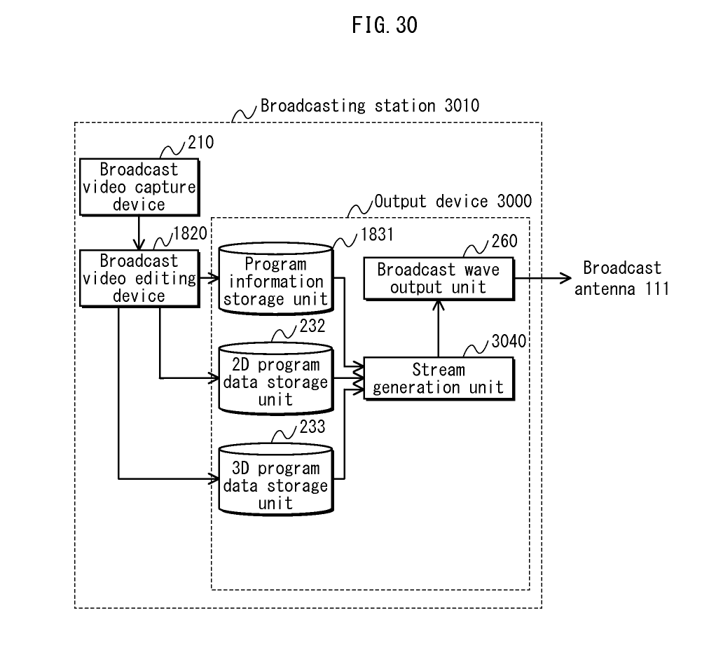

FIG. 30 indicates the overall configuration of the broadcasting station 3010.

As shown, the broadcasting station 3010 differs from the broadcasting station 1810 pertaining to Embodiment 2 (see FIG. 18) in that the broadcast wave stream generation unit 1840, the Internet stream generation unit 1850, and the Internet output unit 270 have been removed, and in that a stream generator 3040 has been added.

The stream generator 3040 is connected to the program information storage unit 1831, the 2D program data storage unit 232, and the broadcast wave output unit 260, and generates a broadcast wave stream in MPEG-2 TS format by multiplexing the 2D program data stored in the 2D program data storage unit 232 with the first program information stored in the program information storage unit 1831, the 3D program data stored in the 3D program data storage unit 233, and the second program information stored in the program information storage unit 1831.

The broadcasting station 3010, configured as described above, transmits the broadcast wave stream including the 2D program data, the first program information, the 3D program data, and the second program information.

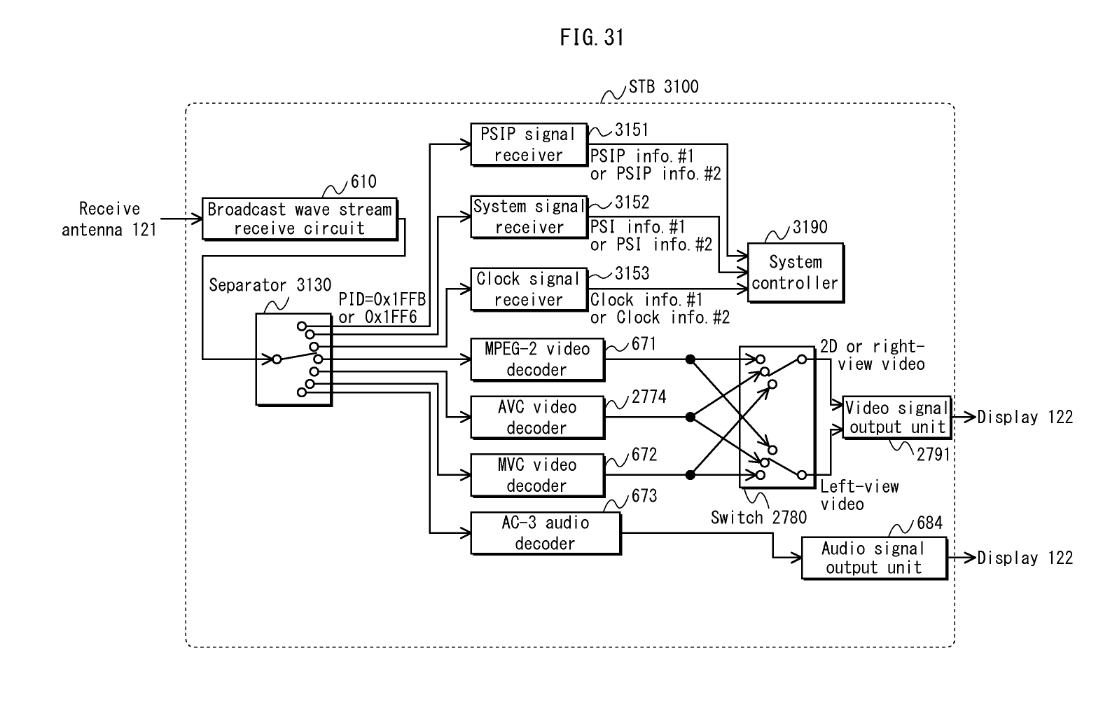

FIG. 31 indicates the overall configuration of the STB 3100.

As shown, the STB 3100 differs from the STB 2700 pertaining to Embodiment 2 (see FIG. 27) in that the Internet stream receive circuit 620, the synchroniser 2721, the second separator 2740, the PSIP signal receiver 2761, the system signal receiver 2762, and the clock signal receiver 2763 have been removed, the first separator 2730 has been replaced by a separator 3130, the PSIP signal receiver 2751 has been replaced by a PSIP signal receiver 3151, the system signal receiver 2752 has been replaced by a system signal receiver 3152, the clock signal receiver 2753 has been replaced by a clock signal receiver 3153, and the system controller 2790 has been replaced by a system controller 3190.

The separator 3130 partially differs in function from the first separator 2730 pertaining to Embodiment 2, is connected to the broadcast wave stream receive circuit 610, the PSIP signal receiver 3151, the system signal receiver 3152, the clock signal receiver 3153, the MPEG-2 video decoder 671, the AVC video decoder 2774, the MVC video decoder 672, and the AC-3 audio decoder 673, separates the packets making up the broadcast wave stream output by the broadcast wave stream receive circuit 610, and outputs each packet in accordance with the PID to one of the PSIP signal receiver 3151, the system signal receiver 3152, the clock signal receiver 3153, the MPEG-2 video decoder 671, the AVC video decoder 2774, the MVC video decoder 672, and the AC-3 audio decoder 673.

The separator 3130 outputs each packet having a PID that corresponds to one of the above-listed destinations, and does not output any packet having a PID that does not correspond to one of the above-listed destinations.

The correspondence between the packet PIDs and the destinations is established by the system controller 2890, with the exception of PID values of 0x1FFB and 0x1FF6. The PID values of 0x1FF6 and 0x1FF6 are fixed as corresponding to the PSIP signal receiver 2751.

The PSIP signal receiver 3151 partially differs in function from the PSIP signal receiver 2751 of Embodiment 2, is connected to the separator 3130 and the system controller 3190, and realises the following two functions:

PSIP info. #1 Acquisition: receiving the packets having a PID value of 0x1FFB output from the separator 3130, acquiring the PSIP information (labelled PSIP info. #1) from the MGT and VCT in the received packets, and outputting the information to the system controller 2790.

PSIP info. #2 Acquisition: receiving the packets having a PID value of 0x1FF6 output from the separator 3130, acquiring the PSIP information (labelled PSIP info. #2) from the MGT and VCT in the received packets, and outputting the information to the system controller 2790.

The system signal receiver 3152 partially differs in function from the system signal receiver 2752 of Embodiment 2, is connected to the separator 3130 and the system controller 3190, receives packets output from the separator 3130, generates 2D program system control information (labelled PSI info. #1) and/or 3D program system control information (labelled PSI info. #2) from the system control information transported by the PAT and PMT in the received packets, and outputs the information to the system controller 3190.

The clock signal receiver 3153 partially differs in function from the clock signal receiver 2753 of Embodiment 2, is connected to the separator 3130 and the system controller 3190, generates 2D program STC information (labelled Clock info. #1) and/or 3D program STC information (labelled Clock info. #2) using a system base clock (i.e., PCR packets for generating the STC) output by the separator 3130, and outputs the information to the system controller 2790.

The system controller 3190 partially differs in function from the system controller 2790 of Embodiment 2, is connected to the PSIP signal receiver 3151, the system signal receiver 2752, and the clock signal receiver 2753, and has the following six functions:

Variant First Separator Control: when PSIP info. #1 is input from PSIP signal receiver 3151 and PSIP info. #2 is not input from PSIP signal receiver 3151, associating the PIDs and destinations for the separator 3130 in accordance with PSIP info. #1 such that the 2D program in the broadcast wave stream is played back correctly.

The PIDs and destinations are associated as follows: packets including a PSI have a PID associated with the system signal receiver 3152, packets including a PCR have a PID associated with the clock signal receiver 3153, packets including video data encoded in MPEG-2 format have a PID associated with the MPEG-2 video decoder 671, packets including video data encoded in MPEG-4 AVC format have a PID associated with the AVC video decoder 2774, packets including video data encoded in MPEG-4 MVC format have a PID associated with the MVC video decoder 672, and packets including audio data have a PID associated with the AC-3 audio decoder 673.

Variant Second Separator Control: when PSIP info. #2 is input from PSIP signal receiver 3151, associating the PIDs and destinations for the separator 3130 in accordance with PSIP info. #2 such that the 3D program in the broadcast wave stream is played back correctly.

As for the Variant First Separator function, the PIDs and destinations are associated as follows: packets including a PSI have a PID associated with the system signal receiver 3152, packets including a PCR have a PID associated with the clock signal receiver 3153, packets including video data encoded in MPEG-2 format have a PID associated with the MPEG-2 video decoder 671, packets including video data encoded in MPEG-4 AVC format have a PID associated with the AVC video decoder 2774, packets including video data encoded in MPEG-4 MVC format have a PID associated with the MVC video decoder 672, and packets including audio data have a PID associated with the AC-3 audio decoder 673.

First System Control: when PSIP info. #1 is input from PSIP signal receiver 3151 and PSIP info. #2 is not input from PSIP signal receiver 3151, controlling the STB 3100 in accordance with the PSI info. #1 output from the system signal receiver 3152.

Second System Control: when PSIP info. #2 is input from PSIP signal receiver 3151, controlling the STB 3100 in accordance with the PSI info. #2 output from the system signal receiver 3152.

First Clock Control: when PSIP info. #1 is input from PSIP signal receiver 3151 and PSIP info. #2 is not input from PSIP signal receiver 3151, generating the STC in accordance with the Clock info. #1 output from the clock signal receiver 3153.

Second Clock Control: when PSIP info. #2 is input from PSIP signal receiver 3151, generating the STC in accordance with the Clock info. #2 output from the clock signal receiver 3153.

The STB 3100, configured as described above, realises equivalent functions to the STB 2700 pertaining to Embodiment 2.

### (Supplement)

Although the reception device pertaining to the present disclosure has been described above as the STB of Embodiment 1, Variation 1, Embodiment 2, and Variation 2, no limitation is intended, and the following variations are also applicable thereto. Also, although the transmission device pertaining to the present disclosure has been described above as the output device of Embodiment 1, Variation 1, Embodiment 2, and Variation 2, no limitation is intend, and the following variations are also applicable thereto.

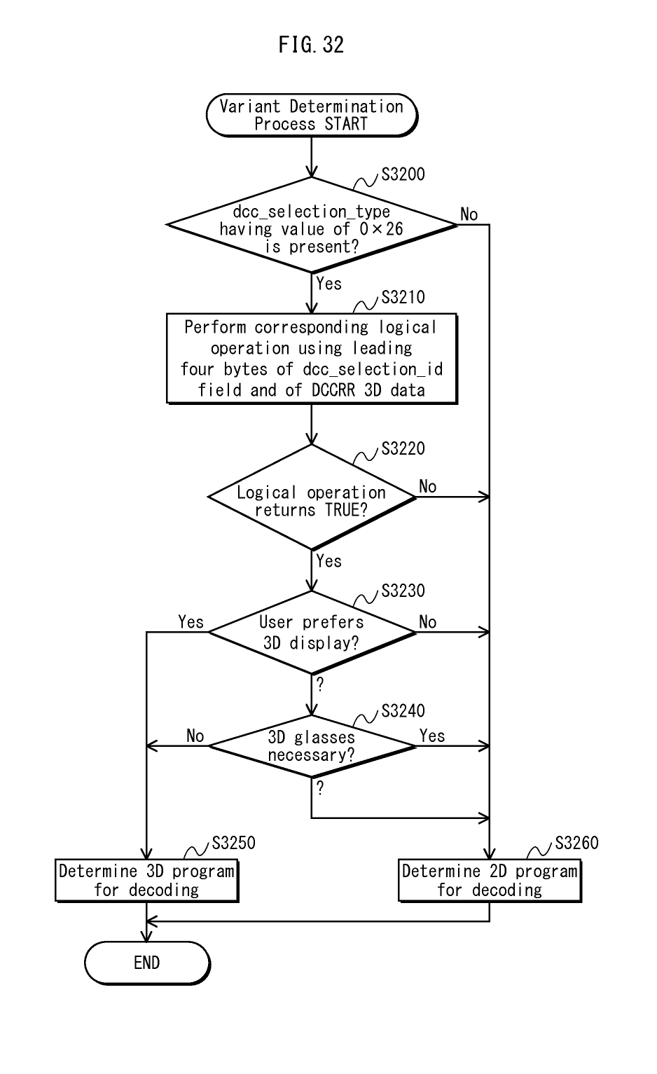

(1) In Embodiment 1, upon receiving broadcast wave stream and the Internet stream transmitted by the broadcasting station 110, the STB 120 performs the determination process depicted in FIG. 9 in order to determine whether the playback target is to be the 2D program in the broadcast wave stream or the 3D program in the Internet stream. However, the determination process of FIG. 9 need not necessarily be used, provided that the determination is performed according to the program information in the broadcast wave stream and the DCCRR 3D data stored in the device. For instance, a variant determination process depicted in FIG. 32 may also be used.

FIG. 32 is a flowchart of the variant determination process.

The variant determination process starts when the program information is separated and output from the first data separator 661 to the determiner 640.

Once the variant determination process starts, the determiner 640 checks whether or not the dcc_selection_type field having a value of 0x26 is present in the program information output by the first data separator 661 (step S3200).

In the affirmative case (Yes in step S3200), the determiner 640 uses the leading four bytes of the dcc_selection_id field and the leading four bytes of the DCCRR 3D data stored in the DCCRR data storage unit 630 to execute a logical operation associated with the case dcc_selection_type=0x26 (step S3210).

When step S3210 is completed, the determiner 640 checks whether the executed logical operation has returned a result of TRUE (step S3220).

In the affirmative case (Yes in Step S3220), the determiner 640 references the User preference term of the DCCRR 3D data to check whether or not the user of the device prefers 3D viewing to 2D viewing (step S3230). Specifically, the User preference term determines that 3D is preferred when Y is indicated, that 3D is not preferred when N is indicated, and that the 3D preference is uncertain when ? is indicated.

When the 3D preference is uncertain (? in step S3230), the determiner 640 references the 3D glasses necessity term of the DCCRR 3D data to check whether or not the 3D glasses are necessary for 3D viewing (step S3240). Specifically, the 3D glasses necessity term determines that 3D glasses are necessary when Y is indicated, that 3D glasses are not necessary when N is indicated, and that the necessity of 3D glasses is uncertain when ? is indicated.

When the result of step S3230 is affirmative or the result of step S3240 is negative (Yes in S3230 or No in S3240), the determiner 640 determines that the 3D program in the Internet stream is to be played back (step S3250).

When the result of step S3200, S3220, or S3230 is negative (No in steps S3200, S3220, or S3230), when the result of step S3240 is affirmative (Yes in step S3240), or when the result of step S3240 is uncertain (? in step S3240), the determiner 640 determines that the 2D program in the broadcast wave stream is to be played back (step S3260).

The STB 120 ends the variant determination process when the process of step S3250 or of step S3260 ends.

(2) In Embodiment 1, a broadcasting system 100 is described as a reception device that includes the STB 120 and a display 122 in program playback system, and plays back the program broadcast by the broadcasting station 110. However, the program playback system need not necessarily be made up of both the STB 120 and the display 122, provided that the function of playing back the program broadcast from the broadcasting station 110 is executed. For example, the program playback system may be configured as a television having the functions of the STB 120 and the display 122.
(3) In Embodiment 1, the broadcasting station 110 is described as transmitting a 2D program using broadcast waves and transmitting a 3D program via the communications network 130. However, no limitation is intended, provided that the 2D program and the 3D program are transmitted in a manner receivable by the reception device. For instance, the 2D program and the 3D program may be transmitted over a satellite communication line for a reception device capable of receiving transmissions via satellite.
(4) In Embodiment 1, when the 2D program and the 3D program are transmitted, the STB 120 is described as selecting one of the programs for playback by (1) receiving the 2D program and the 3D program, (b) decoding a selected program for playback, and (c) outputting the decoded program. However, no such limitation is intended provided that the received program selected for playback is decoded and output. For example, the following may be performed: (a) selecting and receiving only one of the 2D program and the 3D program; (b) decoding the received program; and (c) outputting the decoded program. Alternatively, the following may be performed: (a) receiving the 2D program and the 3D program; (b) decoding the 2D program and the 3D program; and (c) selecting a program for playback and outputting only the selected and decoded program.
(5) In Embodiment 1, the 3D video stream is described as being encoded in MPEG-4 MVC format. However, no such limitation is intended, provided that the stream is playable as 3D video. For example, the stream may be encoded in side-by-side format.
(6) In Embodiment 1, the broadcasting station 110 is described as multiplexing the program information with the 2D program data for transmission. However, no such limitation is intended provided that the reception device is able to receive the transmitted format. For example, the program information may be transmitted independently from the 2D program data.
(7) In Embodiment 1, the broadcasting station 110 is described as using broadcast waves to transmit the program information. However, no such limitation is intended provided that the reception device is able to receive the transmitted format. For example, the program information may be transmitted using the communications network 130. Alternatively, the program information may be transmitted over a public telephone network for a reception device capable of receiving data from such a network.
(8) In Embodiment 1, the dcc_selection_id field is described as a 64-bit sequence diagrammed in FIG. 3. However, no such limitation is intended, provided that information is included indicating the playback requirements made to the STB in order to play back the corresponding program.
(9) In Embodiment 1, the newly-defined dcc_selection_type field is described as indicated in FIG. 4. However, no such limitation is intended provided that the signal specifies the logical operation applied in order for the determiner 640 to realise the playback program determination.
(10) In Embodiment 1, the DCCRR 3D data is described as a 64-bit sequence illustrated in FIG. 7. However, no such limitation is intended provided that information is included corresponding to the dcc_selection_id field indicating the processing capability for program playback of the playback system.
(11) In Embodiment 1, the logical operation performed on the base units is described in the truth table of FIG. 8. However, no such limitation is intended provided that the results of the operation are resolved as being either true or false.
(12) In Embodiment 1, the dcc_selection_id field is described as including a 3D decoder necessity field that serves to determine whether or not the decoder being able to decode 3D video is to be a playback requirement. In contrast, when a plurality of 3D video encoding formats are employed, the field may be used to determine whether or not the decoder being able to decode 3D video in that number of 3D video encoding formats is to be a playback requirement. In such a case, the DCCRR 3D data may include terms to this effect, in a quantity corresponding to the number of 3D video encoding methods.
(13) In Embodiment 1, the dcc_selection_id field includes a 3D video format is 1080i frame packing term that serves to determine whether or not the display being compatible with the 1920×1080 @ 60i per eye 3D video format is to be a playback requirement. In contrast, the term may also be used to determine whether or not the display being compatible with a 1920×1080 @ 50i per eye 3D video format is to be a playback requirement. In such a case, the 3D TV capability for 1080i frame packing term in the DCCRR 3D data indicates whether or not the display connected to the device is capable of using the 1920×1080 @ 50i per eye frame packing format. 60 Hz signals are used in North America, but 50 Hz signals are used in Europe and other regions.
(14) In Embodiment 1, upon determining that the user prefers a relatively strong 3D effect, the STB 120 decodes the 3D video stream with stronger 3D intensity. However, a configuration is also possible in which the STB 120 selects and plays back a program with greater 3D intensity when 3D programs that differ in intensity are broadcast in parallel.
(15) In Embodiment 1, the terms within the dcc_selection_id field are described as being set to one of ASCII Y, N, and ?. However, the terms may also be set to one of ASCII Y and N. Similarly, the terms within the DCCRR 3D data are described as being set to one of ASCII Y, N, and ?. However, the terms may also be set to one of ASCII Y and N.
(16) In Embodiment 1, the terms within the dcc_selection_id field are described as being an 8-bit sequence where each term is set to one of ASCII Y, N, and ?. However, no such limitation is intended as long as each term is set to one of three values corresponding to ASCII Y, N, and ?. For instance, the fields may each be set to one of ASCII 0, 1, and 2.

Similarly, the terms within the DCCRR 3D data are described as being an 8-bit sequence where each term is set to one of ASCII Y, N, and ?. However, no such limitation is intended as long as each term is set to one of three values corresponding to ASCII Y, N, and ?. For instance, the terms may each be set to one of ASCII 0, 1, and 2.

Furthermore, the terms of the dcc_selection_id field need not necessarily be an 8-bit sequence, provided that each term is set to one of three values corresponding to ASCII Y, N, and ?. For instance, 2-bit sequences may used, each being set to one of 0b00, 0b01, and 0b10, respectively corresponding to Y, N, and ?.

Furthermore, the terms of the DCCRR 3D data need not necessarily be an 8-bit sequence, provided that each term is set to one of three values corresponding to ASCII Y, N, and ?. For instance, a 2-bit sequence may used, being set to one of 0b00, 0b01, and 0b10, respectively corresponding to Y, N, and ?.

(17) In Embodiment 1, the terms of the dcc_selection_id field are described as being associated with a playback requirement or with a confirmation requirement. However, no such limitation is intended.

For example, a configuration in which one such term is associated with a requirement (hereinafter termed a specific process execution requirement) for executing an STB-specific process when playing back a program (e.g., a process causing the display to show a specific message). In such a case, the term is used to establish whether or not the corresponding specific process execution requirement is a requirement for a 3D program.

(18) In Embodiment 1, the determiner 640 is described as using a newly-defined dcc_selection_type field to transmit information specifying a logical operation applied in order to realise the playback program determination. However, no such limitation is intended provided that information is transmitted specifying the logical operation applied to realise playback program determination. For instance, a dcc_term_descriptor( ) field within the DCC, unused in the ATSC standards, may be adapted for this purpose.
(19) In Embodiment 2, the new MGT and the new VCT are described as having a fixed PID of 0x1FF6. However, no limitation is intended. Any value other than 0x 1FFB may be used.
(20) The above-described Embodiments and Variations may be freely combined.
(21) The following describes further effects of the reception device and the transmission device as various aspects and variations thereof.

In one aspect, a reception device receives program data transmitted by an outside transmission device, the reception device comprising: an information storage unit storing first information that includes processing capability information for playing back the program data and user preference information relating to a viewing mode for programming; an information reception unit receiving second information that is associated with a program and indicates a condition for determining the viewing mode for programming; a determination unit using the first information stored in the information storage unit and the second information received by the information reception unit to make a determination of the viewing mode for programming associated with the second information; and a decoded output unit decoding and outputting the program data of the program associated with the second information, in the viewing mode determined by the determination unit.

According to this configuration, the transmission device is able to determine a viewing mode for programming in an environment where information indicating a condition for determining the viewing mode of the program broadcast is broadcast by a broadcaster. This enables playback control to be performed in a manner suited to the viewing mode.

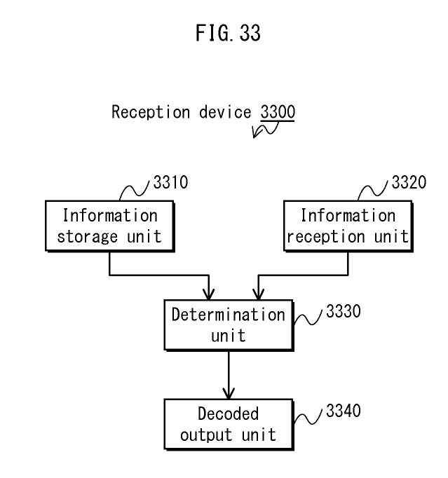

FIG. 33 is a schematic diagram of a reception device 3300 pertaining to the above-described aspect.

As shown, the reception device 3300 includes an information storage unit 3310, information reception unit 3320, a determination unit 3330, and a decoded output unit 3340.

The information storage unit 3310 stores information indicating a processing capability for playing back program data and first information that includes information indicating a user preference concerning a program viewing mode. For instance, this may be realised as the DCCRR data storage unit 630 of Embodiment 1.

The information reception unit receives second information indicating a playback condition for the program data having information associated with a program. For instance, this may be realised as the broadcast wave stream receive circuit 610 of Embodiment 1.

The determination unit 3330 uses the first information stored in the information storage unit 3310 and the second information received by the information reception unit 3320 to determine the viewing mode for the programming associated with the second information. For instance, this may be realised as the determiner 640 of Embodiment 1.

The decoded output unit 3340 decodes and outputs the program data associated with the second information in the viewing mode determined by the determination unit 3330. For instance, this may be realised by a block including the selector 650, the MPEG-2 video decoder 671, the MVC video decoder 672, the AC-3 audio decoder 673, the video signal output unit 683, and the audio signal output unit 684 of Embodiment 1.

In another aspect, the second information includes indicator information indicating whether to make the determination of the viewing mode by (i) using both the processing capability information for playing back the program data and the user preference information relating to the viewing mode for programming, or (ii) using the processing capability information for playing back the program data without using the user preference information relating to the viewing mode for programming.

According to this configuration, a designation is made as to whether or not information indicating a user preference regarding a viewing mode for programming is employed in determining the viewing mode.

In a further aspect, the first information and the second information are digital signals each made up of a bit sequence, and the determination unit makes the determination according to a result of a logical operation performed on at least a portion of the bit sequence making up the first information and at least a portion of the bit sequence making up the second information.

According to this configuration, a determination is made according to a logical operation performed on bit sequences, determining whether or not to play back the program.

In an additional aspect, the program data of the program associated with the second information has been encoded, the first information includes first processing capability information pertaining to processing required between decoding and displaying the program data that is encoded, the second information includes a first condition pertaining to a processing capability of the processing required between decoding and displaying the program data associated with the second information, and the determination unit performs the logical operation on at least a portion of a bit sequence representing the first processing capability information and at least a portion of a bit sequence representing the first condition.

According to this configuration, a determination regarding whether or not to play back the program is made according to the processing capability required for processing from decoding to display.

In yet another aspect, the program data of the program associated with the second information has been encoded using a specific encoding method, the first processing capability information includes a decoding capability for the program data encoded using the specific encoding method, the first condition includes a decoding capability condition pertaining to the decoding capability, and the determination unit performs the logical operation on a bit sequence representing the decoding capability and a bit sequence representing the decoding capability condition.

According to this configuration, a determination regarding whether or not to play back the program is made according to decoding capability.

In an additional further aspect, the viewing mode of the program associated with the second information includes a first viewing mode, the first processing capability includes a format conversion capability for converting data in the first viewing mode into a second viewing mode, the first condition includes a format conversion condition pertaining to the format conversion capability, and the determination unit performs the logical operation on a bit sequence representing the format conversion capability and a bit sequence representing the format conversion condition.

According to this configuration, a determination regarding whether or not to play back the program is made according to format conversion capability.

In yet a further aspect, the viewing mode of the program associated with the second information includes a specific viewing mode, the first processing capability information includes a display capability for displaying the program in the specific viewing mode, the first condition includes a display capability condition pertaining to the display capability, and the determination unit performs the logical operation on a bit sequence representing the display capability and a bit sequence representing the display capability condition.

According to this configuration, a determination regarding whether or not to play back the program is made according to display capability.

In yet an additional aspect, the viewing mode of the program associated with the second information includes a specific viewing mode, the user preference information relating to the viewing mode for programming in the first information includes preference information pertaining to the specific viewing mode, the condition indicated by the second information includes a viewing condition for determining whether or not the program is to be viewed in the specific viewing mode, and the determination unit performs a further determination according to a result of a logical operation performed on a bit sequence representing the preference information and a bit sequence representing the viewing condition.

According to this configuration, a determination regarding whether or not to view the program in a specific viewing mode is made according to a user preference for the specific viewing mode.

In addition, the second information further includes calculation information indicating a calculation method for the logical operation performed by the determination unit, and the determination unit performs the logical operation in accordance with the calculation method indicated by the calculation information.

According to this configuration, the logical operation calculation method is determined.

In an aspect of the transmission device, a data storage unit storing data for a program; an information storage unit storing information indicating a condition for determining a viewing mode for programming stored in the data storage unit; and a transmission unit transmitting the data for the program stored in the data storage unit and the information stored in the information storage unit that is associated with the program.

According to this configuration, the transmission device is able to supply a condition for determining the program viewing mode to the reception device receiving program data.

### INDUSTRIAL APPLICABILITY

The reception device of the present disclosure is widely applicable to devices receiving television programs. Also, the transmission device of the present disclosure is widely applicable to devices transmitting television programs.

### LIST OF REFERENCE SIGNS

120 STB
610 Broadcast wave stream receive circuit
620 Internet stream receive circuit
630 DCCRR data storage unit
640 Determiner
650 Selector
661 First data separator
662 Second data separator
671 MPEG-2 video decoder
672 MVC video decoder
673 AC-3 audio decoder
681 User information receiver
682 Display information collector
683 Video signal output unit
684 Audio signal output unit
685 Message generator

1. A reception device receiving program data transmitted by an outside transmission device, the reception device comprising:
an information storage unit storing first information that includes processing capability information for playing back the program data and user preference information relating to a viewing mode for programming;
an information reception unit receiving second information that is associated with a program and indicates a condition for determining the viewing mode for programming;
a determination unit using the first information stored in the information storage unit and the second information received by the information reception unit to make a determination of the viewing mode for programming associated with the second information; and
a decoded output unit decoding and outputting the program data of the program associated with the second information, in the viewing mode determined by the determination unit.

2. The reception device of claim 1, wherein
the second information includes indicator information indicating whether to make the determination of the viewing mode by (i) using both the processing capability information for playing back the program data and the user preference information relating to the viewing mode for programming, or (ii) using the processing capability information for playing back the program data without using the user preference information relating to the viewing mode for programming.

3. The reception device of claim 2, wherein
the first information and the second information are digital signals each made up of a bit sequence, and
the determination unit makes the determination according to a result of a logical operation performed on at least a portion of the bit sequence making up the first information and at least a portion of the bit sequence making up the second information.

4. The reception device of claim 3, wherein
the program data of the program associated with the second information has been encoded,
the first information includes first processing capability information pertaining to processing required between decoding and displaying the program data that is encoded,
the second information includes a first condition pertaining to a processing capability of the processing required between decoding and displaying the program data associated with the second information, and
the determination unit performs the logical operation on at least a portion of a bit sequence representing the first processing capability information and at least a portion of a bit sequence representing the first condition.

5. The reception device of claim 4, wherein
the program data of the program associated with the second information has been encoded using a specific encoding method,
the first processing capability information includes a decoding capability for the program data encoded using the specific encoding method,
the first condition includes a decoding capability condition pertaining to the decoding capability, and
the determination unit performs the logical operation on a bit sequence representing the decoding capability and a bit sequence representing the decoding capability condition.

6. The reception device of claim 4, wherein
the viewing mode of the program associated with the second information includes a first viewing mode,
the first processing capability includes a format conversion capability for converting data in the first viewing mode into a second viewing mode,
the first condition includes a format conversion condition pertaining to the format conversion capability, and
the determination unit performs the logical operation on a bit sequence representing the format conversion capability and a bit sequence representing the format conversion condition.

7. The reception device of claim 4, wherein
the viewing mode of the program associated with the second information includes a specific viewing mode,
the first processing capability information includes a display capability for displaying the program in the specific viewing mode,
the first condition includes a display capability condition pertaining to the display capability, and
the determination unit performs the logical operation on a bit sequence representing the display capability and a bit sequence representing the display capability condition.

8. The reception device of claim 4, wherein
the viewing mode of the program associated with the second information includes a specific viewing mode,
the user preference information relating to the viewing mode for programming in the first information includes preference information pertaining to the specific viewing mode,
the condition indicated by the second information includes a viewing condition for determining whether or not the program is to be viewed in the specific viewing mode, and
the determination unit performs a further determination according to a result of a logical operation performed on a bit sequence representing the preference information and a bit sequence representing the viewing condition.

9. The reception device of claim 4, wherein
the second information further includes calculation information indicating a calculation method for the logical operation performed by the determination unit, and
the determination unit performs the logical operation in accordance with the calculation method indicated by the calculation information.

10. A transmission device, comprising:
a data storage unit storing data for a program;
an information storage unit storing information indicating a condition for determining a viewing mode for programming stored in the data storage unit; and
a transmission unit transmitting the data for the program stored in the data storage unit and the information stored in the information storage unit that is associated with the program.

11. The transmission device of claim 10, wherein
the data for the program stored in the data storage unit is encoded, and
the information stored in the information storage unit is a digital signal indicating a condition pertaining to a processing capability for processing required between decoding and displaying the encoded data for the program.

12. The transmission device of claim 11, wherein
the viewing mode for programming stored in the data storage unit includes a specific viewing mode, and
the condition indicated by the information stored in the information storage unit includes a viewing condition for determining whether or not the program is to be viewed in the specific viewing mode.

13. A reception method executed by a receiving device receiving program data transmitted by an outside transmission device, the reception device including: an information storage unit storing first information that includes processing capability information for playing back the program data and user preference information relating to a viewing mode for programming; and an information reception unit receiving second information that is associated with a program and indicates a condition for determining the viewing mode for programming, the reception method comprising:
a determination step of using the first information stored in the information storage unit and the second information received by the information reception unit to make a determination of the viewing mode for programming associated with the second information; and
a decoded output step of decoding and outputting the program data of the program associated with the second information, in the viewing mode determined in the determination step.

14. A transmission method executed by a transmission device that includes: a data storage unit storing data for a program; and an information storage unit storing information indicating a condition for determining a viewing mode for programming stored in the data storage unit, the transmission method comprising
a transmission step of transmitting the data for the program stored in the data storage unit and the information stored in the information storage unit that is associated with the program.
